(19) United States
(12) Patent Application Publication
(10) Pub. No.: US 2006/0057275 A1
(43) Pub. Date: Mar. 16, 2006

(54) Process for the preparation of glycinin-rich and beta-conglycinin-rich protein fractions

(76) Inventors: Shaowen Wu, St. Louis, MO (US); Cameron Lusk, Eureka, MO (US); Phillip S. Kerr, Wildwood, MO (US); Felix Johnson, Bernex (CH); Traci Rector, St. Louis, MO (US)

Correspondence Address: SOLAE, LLC, P. O. BOX 88940, ST. LOUIS, MO, 63188, US

(21) Appl. No.: 10/942,231

(22) Filed: Sep. 16, 2004

(51) Int. Cl. A23J 1/00

(52) U.S. Cl. 426/656

(57) ABSTRACT

This invention relates to processes for preparing vegetable protein fractions suitable for use as functional food ingredients, novel vegetable proteins suitable for use as functional food ingredients, and food products containing the novel vegetable protein fractions.

### FIELD OF THE INVENTION

This invention relates to processes for preparing vegetable protein fractions suitable for use as functional food ingredients, novel vegetable protein fractions suitable for use as functional food ingredients, and food products containing the novel vegetable protein fractions.

### BACKGROUND OF THE INVENTION

Plant protein materials are used as functional food ingredients, and have numerous applications in enhancing desirable characteristics in food products. Soy protein materials, in particular, have seen extensive use as functional food ingredients. Soy protein materials are used as an emulsifier in meats, including frankfurters, sausages, bologna, ground and minced meats, and meat patties, to bind the meat and give the meat a good texture and a firm bite. Another common application for soy protein materials as functional food ingredients is in creamed soups, gravies, and yogurts where the soy protein material acts as a thickening agent and provides a creamy viscosity to the food product. Soy protein materials are also used as functional food ingredients in numerous other food products such as dips, dairy products (for example, soy milk), tuna, breads, cakes, macaroni, confections, whipped toppings, baked goods, beverages (e.g., fruit juice), and many other applications.

Soy protein materials are generally in the form of soy flakes, soy protein concentrates, or soy protein isolates. Soy flakes are generally produced by dehulling, defatting, and grinding the soybean and typically contain less than 65 wt. % soy protein on a moisture-free basis (more generally from 45 wt. % to 65 wt. % soy protein on a moisture-free basis). Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from defatted soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Kunitz trypsin inhibitors. Heat treating the ground, defatted flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than 150 μm. Soy grits generally have a particle size of 150 to 1000 μm. Soy meal generally has a particle size of greater than 1000 μm.

Soy protein concentrates typically contain 65 wt. % to 85 wt. % soy protein, with the major non-protein component being fiber. Soy protein concentrates may be formed from defatted soy flakes by washing the flakes with either an aqueous alcohol solution or an acidic aqueous solution to remove the soluble carbohydrates from the protein and fiber. On a commercial scale, considerable expense is incurred in the handling and disposing of the resulting waste stream.

Soy protein isolates, more highly refined soy protein materials, are processed to contain at least 90% soy protein and little or no soluble carbohydrates or fiber. Soy protein isolates are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is then treated with an acid to adjust the pH of the extract to the isoelectric point of the protein to precipitate the protein from the extract. The precipitated protein is separated from the extract, which retains the soluble carbohydrates, and is dried after being adjusted to a neutral pH or is dried without any pH adjustment.

Soy protein provides gelling properties which contribute to the texture in ground and emulsified meat products. The gel structure provides dimensional stability to a cooked meat emulsion which gives the cooked meat emulsion a firm texture and gives chewiness to the cooked meat emulsion, as well as provides a matrix for retaining moisture and fats. Soy protein also acts as an emulsifier in various food applications since soy proteins are surface active and collect at oil-water interfaces, inhibiting the coalescence of fat and oil droplets. The emulsification properties of soy protein allows soy protein containing materials to be used to thicken food products such as soups and gravies. Soy protein further absorbs fat, likely as a function of its emulsification properties, and promotes fat binding in cooked foods, thereby decreasing “fatting out” of the fat in the process of cooking. Soy proteins also function to absorb water and retain it in finished food products. The moisture retention of a soy protein material may be utilized to decrease cooking loss of moisture in a meat product, providing a yield gain in the cooked weight of the meat. The retained water in the finished food products is also useful for providing a more tender mouthfeel to the product.

Naturally occurring soy proteins are generally globular proteins having a hydrophobic core surrounded by a hydrophilic shell. Numerous soy protein fractions have been identified including, for example, storage proteins such as glycinin and β-conglycinin and trypsin inhibitors such as the Bowman-Birk inhibitor and the Kunitz inhibitor. Soy protein fractions have also been characterized by their ultracentrifugation rates, in terms of their Svedberg coefficient (S). 2S, 7S (i.e., β-conglycinin), 11S (i.e., glycinin), and 15S soy proteins have been identified.

Protein fractions (e.g., β-conglycinin-rich or glycinin-rich fractions) have been precipitated from solution of a soy protein material at a pH from 4.0 to 5.0. Proteins remaining soluble in water throughout the precipitation range are commonly referred to as whey proteins.

Various processes for fractionation of protein fractions are described in the art. U.S. Pat. No. 4,368,151 to Howard et al. describes a process in which aqueous mixtures of water-soluble 7S (β-conglycinin) and 11S (glycinin) proteins are fractionated and isolated by precipitating the 11S protein at a pH 5.8-6.3 in the presence of water-soluble salts and sulfurous ions. The pH of the enriched 7S whey may then be adjusted to a pH of 5.3-5.8 to precipitate substantially all of the remaining water-soluble 11S protein from the whey and an enriched 7S fraction may then be recovered from the whey. The fractionation is described as capable of producing either 11S-rich or 7S-rich isolates which, respectively, contain less than 5% 7S or 11S protein impurities.

Nagano et al. (J. Agric. Food Chem., 1992, Vol. 40, p. 941-944) describe a process in which soy proteins are extracted using water at pH 7.5, sodium bisulfilte was used as a reducing agent, and three protein fractions are precipitated at pH 6.4, 5.0, and 4.8.

Wu et al. (JAOCS, 1999, Vol. 76, No. 3, p. 285-293) describe scale-up of a laboratory process for separating glycinin and β-conglycinin similar to that described by Nagano et al. (J. Agric. Food Chem., 1992, Vol. 40, p. 941-944). In the process described by Wu et al., 15 kilograms of defatted soy flakes are used and precipitation steps at pH 6.4, 5.0, and 4.8 are carried out to produce a glycinin-rich fraction, an intermediate fraction, and a β-conglycinin-rich fraction.

Wu et al. (J. Agric. Food Chem., 2000, Vol. 48, p. 2702-2708) describe a modification of the scaled-up process in which a glycinin-rich fraction is precipitated at pH 6.0 and a β-conglycinin-rich fraction is precipitated at pH 4.5, without precipitation of an intermediate mixture. Wu et al. reported the yield of glycinin-rich fraction by this method as 9.7% (dry basis, db) and the yield of β-conglycinin-rich fraction as 19.6%(db). The protein content of the -conglycinin rich fraction was reported as 91.6% (db) at 62.6% purity.

β-conglycinin rich and glycinin-rich fractions obtained in accordance with the above processes or other processes often exhibit varying functionalities, often making them suitable for incorporation into various food products.

For example, Bian et al. (JAOCS, 2003, Vol. 80, No. 6, p. 545-549) investigated the functional properties of soy proteins fractionated by the methods of Wu et al. (JAOCS, 1999, Vol. 76, No. 3, p. 285-293) and Wu et al. (J. Agric. Food Chem., 2000, Vol. 48, p. 2702-2708). Functional properties of the three fractions produced by the method of Wu et al. (JAOCS, 1999, Vol. 76, No. 3, p. 285-293) β-conglycinin rich, glycinin-rich, and intermediate fractions) are studied by Bian et al. under a selected range of pH, ionic strengths, and protein concentrations. For example, the glycinin-rich fraction was reported to be more soluble than the β-conglycinin rich fraction at pH from 2 to 3 while the -conglycinin rich fraction was reported to be more soluble at than the glycinin-rich fraction at pH from 5 to 6. The glycinin-rich and β-conglycinin rich fractions of the Wu et al. method (J. Agric. Food Chem., 2000, Vol. 48, p. 2702-2708) are reported to have higher solubilities at certain pHs than the fractions produced by the method of Wu et al. (JAOCS, 1999, Vol. 76, No. 3, p. 285-293).

Bringe et al. in U.S. Pat. No. 6,171,640 describe high -conglycinin compositions having improved physical (for example, stability and gelation) and physiological (for example, cholesterol and triglyceride lowering) properties as compared to commercial soy protein ingredients. Bringe reported soy protein compositions containing greater than 40% -conglycinin and less than 10% glycinin.

Fractions precipitated between precipitation of a glycinin-rich fraction and a β-conglycinin-rich fraction (i.e., intermediate fractions) in one or more of the processes described above (e.g., Wu et al. (JAOCS, 1999, Vol. 76, No. 3, p. 285-293)) typically contain less than 80% protein, of which less than 70% is glycinin or β-conglycinin. Such intermediate fractions typically exhibit poor functionality, making them unsuitable for incorporation into food products. In addition to their undesirable functionality characteristics, the protein content of the intermediate fractions typically has an adverse effect on the yield of useful protein fraction.

Each of the processes described above suffer from one or more disadvantages, for example, undesired yield, undesired purity, or producing an undesired intermediate fraction.

Thus, a need exits for a simple and effective method for producing protein fractions and, in particular, protein fractions exhibiting improved functionalities and/or functionalities suitable for particular food applications.

### SUMMARY OF THE INVENTION

Briefly, therefore, the present invention is directed to a process for preparing a glycinin-rich protein fraction and a β-conglycinin-rich protein fraction prepared in a first precipitation and a second precipitation, respectively. In the first precipitation, the pH of a dispersion of soy protein in a liquid medium is adjusted to less than 5.3 to precipitate a glycinin-rich fraction from the dispersion and form a supernatant liquid medium comprising β-conglycinin. The dispersion has an ionic strength of from 0.04 to 0.07 and the glycinin-rich fraction has a protein content of at least 50% by weight glycinin based on the total protein content of the glycinin-rich fraction. The process further comprises separating the glycinin-rich fraction from the supernatant liquid medium. In the second precipitation, a -conglycinin-rich fraction is precipitated from the supernatant liquid medium. The β-conglycinin-rich fraction comprises at least 40% by weight -conglycinin and from 10% to 25% by weight glycinin based on the total protein content of the β-conglycinin-rich fraction.

The present invention is also directed to a process for preparing a glycinin-rich protein fraction and a β-conglycinin-rich protein fraction in which a source of a divalent metal ion is introduced to a dispersion comprising soy protein in a liquid medium. In accordance with this process, a glycinin-rich fraction is precipitated from the dispersion to form a supernatant liquid medium comprising β-conglycinin and the glycinin-rich fraction is separated from the supernatant liquid medium. A β-conglycinin-rich fraction is precipitated from the supernatant liquid medium.

In another embodiment, the present invention is directed to a vegetable protein fraction comprising from 40% to 80% by weight -conglycinin and at least 10% by weight glycinin, based on the total protein content of the fraction. The protein fraction is further characterized by a nitrogen solubility index of at least 80%.

In a still further embodiment, the present invention is directed to a vegetable protein fraction comprising from 50% to 95% by weight glycinin, based on the total protein content of the fraction. The protein fraction is further characterized by a nitrogen solubility index of less than 80%.

The present invention is also directed to a meat substitute comprising a coherent mass comprising water, an edible oil, and at least 10% by weight vegetable protein, the vegetable protein comprising a vegetable protein fraction comprising at least 40% by weight β-conglycinin and at least 10% by weight glycinin, based on the total protein content of the meat substitute. The meat substitute is further characterized by an emulsification capacity of at least 800 grams oil/gram protein.

Other objects and features of this invention will be in part apparent and in part pointed out hereinafter.

### BRIEF DESCRIPTION OF THE DRAWINGS

FIG. 1 is a flowsheet of one embodiment of the process of the present invention.

FIG. 2 is a flowsheet of one embodiment of the process of the present invention.

FIG. 3 shows the effect of β-conglycinin/glycinin content, pH, and the presence of sodium chloride on the viscosity of protein fractions of the present invention.

FIG. 4 shows the effect of β-conglycinin/glycinin content, pH, and the presence of sodium chloride on the viscosity of protein fractions of the present invention.

FIG. 5 shows the effect of pH and the presence of sodium chloride on the viscosity of protein fractions of the present invention.

FIG. 6 shows the effect of pH and the presence of sodium chloride on the viscosity of protein fractions of the present invention.

FIG. 7 shows the effect of CaCl₂ addition on pH in the process described in Example 1.

FIG. 8 shows the effect of CaCl₂ addition on the amount of β-conglycinin-rich fraction recovered in the process described in Example 1.

FIG. 9 shows the protein profile of the glycinin-rich fraction recovered in the process described in Example 1 at varying relative amounts of CaCl₂ addition.

FIG. 10 shows the protein profile of the β-conglycinin-rich fraction recovered in the process described in Example 1 at varying relative amounts of CaCl₂ addition.

FIG. 11 shows the protein profile of the glycinin-rich fraction recovered in the process described in Example 2 at varying CaCl₂ addition pH.

FIG. 12 shows the protein profile of the β-conglycinin-rich fraction recovered in the process described in Example 2 at varying CaCl₂ addition pH.

FIG. 13 shows the protein profile of the β-conglycinin-rich fraction recovered in the process described in Example 3 at varying relative amounts of NaHSO₃ addition.

FIG. 14 shows the protein profile of the glycinin-rich fraction recovered in the process described in Example 4 at varying relative amounts of CaCl₂ addition.

FIG. 15 shows the protein profile of the β-conglycinin-rich fraction recovered in the process described in Example 4 at varying relative amounts of CaCl₂ addition.

FIG. 16 shows the relationship between relative amount of CaCl₂ addition and amount of glycinin-rich fraction and β-conglycinin fraction recovered in the process described in Example 4.

FIG. 17 shows pasteurized gel strengths for gels containing glycinin-rich and β-conglycinin fractions prepared in accordance with the process described in Example 5.

FIG. 18 shows hardness results of products containing a protein fraction of the present invention prepared in accordance with Example 6.

FIG. 19 shows chewiness results of products containing a protein fraction of the present invention produced in accordance with Example 6.

### DETAILED DESCRIPTION OF THE PREFERRED EMBODIMENTS

A process for obtaining glycinin-rich and β-conglycinin-rich protein fractions from a solution or dispersion containing a soy protein material has been discovered. In accordance with such process, a glycinin-rich fraction may be precipitated from a solution or dispersion, the fraction separated, and a β-conglycinin-rich fraction precipitated from the supernatant. The resulting glycinin-rich fractions typically contain at least 80% protein, of which from 50% to 95% is glycinin. β-conglycinin-rich fractions obtained by the process of the present invention typically contain at least 80% by weight protein, of which from 40% to 80% is β-conglycinin. In certain embodiments, a source of a divalent metal ion is introduced to the dispersion to promote precipitation of either or both of the fractions.

The protein fractions of the present invention exhibit functionalities making them suitable for use as functional food ingredients in various food products. It has been observed that fractions having varying glycinin and/or β-conglycinin contents exhibit different functionalities including, for example, solubility and gel strength. Thus, fractions having a particular glycinin and/or β-conglycinin content may be preferred for particular applications. For example, β-conglycinin-rich fractions having a higher glycinin content (e.g., above 10% glycinin, based on the total protein content of the fraction), typically exhibit higher gel strength, an important consideration for meat products, than fractions containing lower amounts of glycinin. Thus, such β-conglycinin-rich fractions are typically preferred for incorporation into meat products. Various functionalities of the fractions and preferred applications for the fractions are discussed in greater detail below.

Advantageously, in certain embodiments, the process of the present invention is operated to include two successive precipitations, each providing a fraction containing a relatively high protein content and enriched in a particular protein (e.g., glycinin or β-conglycinin), as described above, and suitable for incorporation into food products. Thus, the process of the present invention can be operated produce two fractions suitable for incorporation into food applications while avoiding formation of an undesired intermediate fraction.

In accordance with the process of the present invention, protein fractions are precipitated from a soy protein-containing dispersion (i.e., feed stream) generally comprising a vegetable protein material suspended or otherwise dispersed in an aqueous medium (for example, water). The vegetable protein material is typically in the form of soy flakes, soy grits, soy meal, soy flour, soy protein concentrates, soy protein isolates, or combinations thereof. Preferably, the soy protein material is in the form of defatted soy flakes. Typically, the dispersion contains from 5% to 15% by weight soy protein material and, more typically, from 7% to 10% by weight soy protein material.

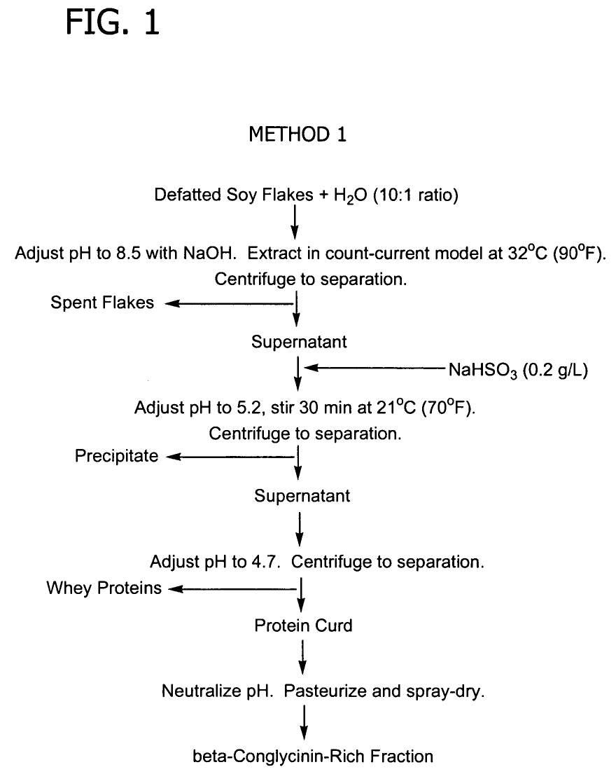

FIG. 1 shows one embodiment of the process of the present invention in which a glycinin-rich fraction and a β-conglycinin-rich fraction are obtained from an aqueous dispersion of defatted soy flakes.

Prior to separation of glycinin-rich and β-conglycinin-rich fractions, a crude mixture of soy proteins and other soluble components (e.g., carbohydrates) may be prepared (e.g., extracted) from the dispersion of the starting material directly or by adjusting the pH of the aqueous dispersion. Typically, the pH of the dispersion comprising the protein material is adjusted to a pH of 7 to 10 and, more typically, to a pH of 8 to 9. The pH of the dispersion is adjusted by contacting the dispersion with an alkaline mixture. Typically, the alkaline mixture comprises a compound selected from the group consisting of sodium hydroxide, calcium hydroxide, and potassium hydroxide.

Extraction of soluble proteins and other components is typically carried out at a temperature of from 15° C. to 60° C. (from 60° F. to 140° F.) and, more typically, from 20° C. to 40° C. (70° F. to 100° F.). This extraction is typically allowed to proceed for at least 5 minutes, more typically, from 10 to 30 minutes.

Extraction of the soluble proteins and other components results in a extract comprising glycinin, β-conglycinin, and other soluble components (e.g., soluble carbohydrates), and an insoluble fraction comprising spent material (e.g., soy fiber) from which protein has been removed.

The insoluble fraction is typically separated from the extract by centrifuging using, for example, a Sharples 3400 decanting centrifuge manufactured by Alfa Laval Separation Inc. (Warminster, Pa.). The insoluble fraction may also be separated from the extract by filtration.

The separated extract typically comprises at least 4% by weight protein and, more typically, from 6% to 8% by weight protein. The separated extract generally comprises at least 40% glycinin and at least 20% β-conglycinin, based on the total protein content.

A reducing agent can be added to the separated extract (i.e., extract) in order to facilitate separation of glycinin and β-conglycinin by reduction of disulfide bonds of the proteins. It is currently believed reduction of the disulfide bonds facilitates this separation by untangling glycinin and β-conglycinin proteins. Glycinin typically contains a greater proportion of disulfide bonds; thus, reducing agent is preferably added prior to adjustment of the extract pH for precipitation of the glycinin-rich fraction. Suitable reducing agents include sodium bisulfite, dithiothreitol, and mercaptoethanol. Preferably, the reducing agent comprises sodium bisulfite since sodium bisulfite satisfies the relevant food-grade regulations.

Typically, at least 0.1 g reducing agent per L extract are introduced thereto, more typically from 0.1 to 1.0 g reducing agent per L extract and, still more typically, from 0.2 to 0.6 g reducing agent per L extract. Introduction of such amounts of reducing agents typically results in suitable reducing agent content in the vegetable protein fractions produced by the present invention for incorporation into food products (e.g., less than 100 parts per million (ppm)). Preferably, any reducing agent is added in such an amount that the concentration of reducing agent in the vegetable fraction is less than 100 p.m., more preferably less than 20 ppm. and, still more preferably, less than 10 ppm.

In accordance with the present process, the pH of the extract, regardless of introduction of a reducing agent thereto, is adjusted to precipitate a glycinin-rich fraction. The pH of the extract is typically adjusted by introducing an acidic mixture comprising a compound selected from the group consisting of hydrochloric acid, phosphoric acid, and sulfuric acid. Preferably, the pH of the extract is adjusted by introduction of an acidic mixture comprising hydrochloric acid.

It has been observed that glycinin precipitation is favored as the pH of the extract decreases, thereby increasing the purity of the glycinin-rich fraction and, accordingly, the precipitation of the β-conglycinin-rich fraction. Typically, the pH of the extract is adjusted from 7.5 to a pH of less than 6.5, from 7.5 to a pH of less than 6.0, from 7.5 to 5.5, for precipitation of the glycinin-rich fraction. For example, the pH of the extract may be adjusted from a pH of 7.5 to a pH less than 5.3 and, in some embodiments, to a pH less than 5.2.

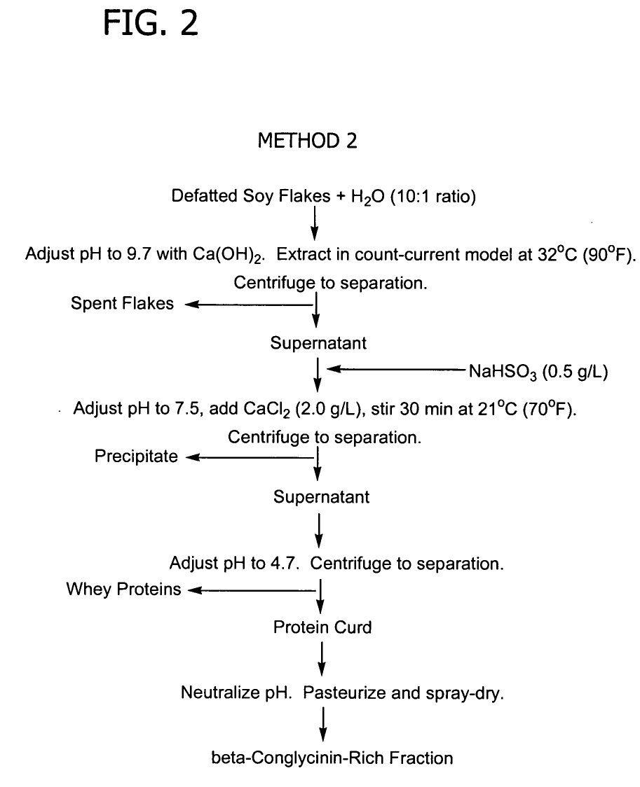

In accordance with the process of the present invention, it has been discovered that addition of a divalent metal ion to the extract enhances separation of the protein fractions. FIG. 2 illustrates an embodiment of the process of the present invention incorporating addition of a source of divalent metal ion to the extract obtained from defatted soy flakes. This favorable effect is presently believed to be due in part to the effect of addition of such an ion on the ionic strength of the extract. Preferably, the ionic strength of the extract is from 0.02 to 0.1 and, more preferably, from 0.04 to 0.07. Providing such ionic strengths of the extract is preferred since it has been observed that at lower ionic strengths (i.e., below 0.02) neither protein fraction precipitates while at higher ionic strengths (i.e., above 0.1) both glycinin and β-conglycinin fractions tend to precipitate; in either case, failing to provide a fraction rich in a particular protein.

In certain embodiments, addition of a divalent metal ion to the extract prior to precipitation of a glycinin-rich fraction provides a glycinin-rich fraction having more uniform particle size and, further advantageously, increased average particle size of precipitated protein as compared to precipitates produced in the absence of a divalent metal ion. Typically, addition of a divalent metal ion results in a glycinin-rich fraction having a particle size distribution, in terms of particle diameter, of from 1 μm to 52 μm. More typically, the particle size distribution is from 2 μm to 16 μm. The average particle size of precipitated protein of a glycinin-rich fraction precipitated in the presence of a divalent metal ion, in terms of particle diameter, is typically at least 5 μm and, more typically, at least 6 μm. Achieving greater uniformity of particle size distribution and increased overall particle size aids in separation of the glycinin-rich fraction.

Suitable sources of the divalent metal ion include salts of alkaline earth metals, for example, calcium and magnesium. In a preferred embodiment, the source of a divalent metal ion comprises CaCl₂ and, in another, MgCl₂.

Typically, the source of divalent metal ion is present in the extract at a concentration of at least 0.01 molar. Additionally or alternatively, the source of a divalent metal ion is present in the extract at a concentration of at least 0.5% by weight. Further additionally or alternatively, at least 0.001 g source of divalent metal ion per liter extract are introduced thereto.

When a divalent metal ion is introduced to the extract, typically the pH of the extract is adjusted from a pH of 6.5 to a pH of less than 5.3 and, more typically, is adjusted from a pH of 6.5 to a pH of 5.0 for precipitation of a glycinin-rich fraction from the extract.

Adjusting the pH of the extract in this manner produces an insoluble glycinin-rich fraction and a soluble fraction comprising β-conglycinin. The precipitation of the glycinin-rich fraction is typically carried out at a temperature of from 15° C. to 35° C. (from 60° F. to 95° F.) and, more typically, from 20° C. to 32° C. (70° F. to 90° F.). During precipitation of the soluble proteins, typically the extract is agitated. Typically, the extract is agitated by stirring. The means and intensity of agitation are not critical but typically are selected so that the extract is agitated to a degree sufficient to promote uniform pH and transfer of proteins from the aqueous to solid phase.

The supernatant produced by precipitation of a glycinin-rich fraction typically comprises at least 3.5% by weight protein, more typically at least 5% by weight protein and, still more typically, from 5% to 7% by weight protein.

The pH of the supernatant is adjusted to precipitate a β-conglycinin-rich fraction typically by introducing an acidic mixture comprising a compound selected from the group consisting of hydrochloric acid, phosphoric acid, and sulfuric acid to the supernatant. Preferably, the pH of the supernatant is adjusted by addition of hydrochloric acid.

Typically, the pH of the supernatant is adjusted from the glycinin precipitation pH to from 4.5 to 5.3 and, more typically, to from 4.6 to 5.0 to precipitate a protein curd comprising a β-conglycinin-rich fraction. Precipitation of the β-conglycinin-rich fraction also forms a supernatant mixture comprising whey proteins soluble over the entire pH range of glycinin and β-conglycinin precipitation. In certain embodiments, it may be desired to recover these soluble proteins and other components.

The precipitated glycinin and β-conglycinin-rich fractions are typically separated from the respective soluble fraction by centrifugation using, for example, a Sharples 3400 decanting centrifuge manufactured by Alfa Laval Separation Inc. (Warminster, Pa.). The precipitated fractions may also be separated by filtration.

Advantageously, the process of the present invention may be operated continuously. That is, once a glycinin-rich fraction is precipitated from a solution or dispersion containing a soy protein material to produce the fraction and a supernatant, the glycinin-rich fraction may be recovered and subjected to further processing (e.g., centrifuging and protein content determination) while precipitation and recovery of a β-conglycinin-rich fraction from the supernatant proceeds in accordance with the discussion set forth above.

Generally, the glycinin-rich fractions of the present invention comprise at least 80% by weight soy protein and, more generally, at least 90% by weight soy protein. The protein content of the soy protein material may be ascertained, for example, by A.O.C.S. (American Oil Chemists Society) Official Methods Bc 4-91(1997), Aa 5-91(1997), or Ba 4d-90(1997), the entire disclosures of which are hereby incorporated by reference.

The process of the present invention provides glycinin-rich fractions having a high degree of purity (i.e., high glycinin content). Typically, the glycinin-rich fraction comprises at least 40% glycinin, more typically at least 50% glycinin, still more typically at least 60% glycinin and, even more typically, at least 70% glycinin, based on the total protein content of the fraction. Generally, the glycinin-rich fractions of the present invention comprise from 50% to 95% glycinin, based on the total protein content.

In certain embodiments, the glycinin-rich fractions of the present invention comprise from 40% to 80% by weight glycinin.

The weight ratio of glycinin to β-conglycinin in a glycinin-rich fraction of the present invention is typically at least 10:1 and, more typically, at least 15:1.

Generally, the β-conglycinin-rich fractions of the present invention comprise at least 80% by weight soy protein and, more generally, at least 90% by weight soy protein. Typically, at least 80% by weight of the soy protein present in the β-conglycinin-rich fraction has a molecular weight of less than 800,000 daltons, more typically at least 60% of the soy protein in the β-conglycinin-rich fraction has a molecular weight of from 1350 to 800,000 daltons and, still more typically, from 1350 to 380,000 daltons.

The process of the present invention provides β-conglycinin-rich fractions having a high degree of purity (i.e., high β-conglycinin content). Typically, the β-conglycinin-rich fraction comprises at least 40% -conglycinin, more typically at least 50% β-conglycinin and, still more typically, at least 70% β-conglycinin, based on the total protein content of the fraction. Preferably, the β-conglycinin-rich fraction comprises from 40% to 75% β-conglycinin and, more preferably, from 40% to 80% β-conglycinin, based on the total protein content of the fraction. Typically, such fractions further comprise at least 10% glycinin, more typically at least 12% glycinin, still more typically at least 15% glycinin, and, even more typically, at least 20% glycinin, based on the total protein content of the fraction. In certain embodiments, such fractions comprise from 10% to 30% glycinin, from 10% to 15% glycinin, or from 15% to 20% glycinin, based on the total protein content of the fraction.

The weight ratio of β-conglycinin to glycinin in a β-conglycinin-rich fraction of the present invention is typically at least 2.5:1, more typically from 3:1 to 5:1 and, still more typically, from 4:1 to 5:1.

Typically, the β-conglycinin-rich fraction comprises at least 40% by weight β-conglycinin and, more typically, at least 50% by weight β-conglycinin. Generally, the β-conglycinin-rich fractions of the present invention comprise from 50% to 75% by weight β-conglycinin.

Typically, most of the soluble carbohydrates remain in the supernatant produced during precipitation of the glycinin-rich and β-conglycinin-rich fractions. Thus, the glycinin or β-conglycinin-enriched fractions of the present invention typically contain less than 1% by weight carbohydrates and, more typically, less than 0.5% by weight carbohydrates.

In addition to protein content, yield and purity of the fraction can be important considerations, for example, as indicators of the effectiveness of the fractionation and likely functionalities of the fractions. Generally, it has been observed that as the yield of a particular protein in a fraction rich in that protein increases, the purity of the fraction decreases. Thus, the present process is preferably operated such that protein yields provide a commercially feasible process while producing fractions of purities sufficient to provide functionalities which make them suitable for use in various food applications.

The present process typically achieves glycinin yields of at least 70%, more typically at least 80% and, still more typically, at least 90%.

Yields of β-conglycinin, based on the β-conglycinin content in the dispersion of protein material and the β-conglycinin present in a β-conglycinin-rich fraction are typically at least 10%. More typically, the present process achieves yields of from 10% to 80% and, still more typically, from 40% to 80%. It has been observed that the purity and, accordingly, functionality, of fractions produced at higher yields suffer.

Typically, the glycinin-rich fraction or β-conglycinin-rich protein curd produced by the process described above are neutralized by addition of an aqueous alkaline composition thereto. Such alkaline compositions typically comprise a compound selected from the group consisting of calcium hydroxide, potassium hydroxide, and sodium hydroxide. Neutralization of the enriched curd solubilizes the proteins present therein.

The fractions of the present invention are then typically further processed to aid in incorporation of the fractions into food products. Such further processing includes, for example, heat treatment to destroy microorganisms present in the fractions (e.g., pasteurization and/or sterilization) and drying (e.g., spray drying). Typically, pasteurization includes heating the fraction to a temperature of at least 95° C. (at least 203° F.), more typically at least 130° C. (265° F.) and, more typically, to a temperature of from 130° C. to 150° C. (from 265° F. to 305° F.).

The fractions may also be spray dried to produce a free-flowing powder typically having a moisture content of less than 5% by weight and, more typically, less than 10% by weight. The fractions are typically spray dried at temperatures of at least 95° C. (200° F.).

Glycinin-rich fractions which have been spray dried are typically in the form of a free-flowing powder having a bulk density from 0.20 to 0.35 g/cm³. These dried protein fractions typically have a particle size distribution such that between 10% by weight and 15% by weight of said powder is retained on a 325 mesh screen, U.S. Sieve size. These fractions may also generally have a particle size distribution such that between 15% by weight and 25% by weight of said powder is retained on a 325 mesh screen, U.S. Sieve size, between 25% by weight and 45% by weight is retained on a 325 mesh screen, U.S. Sieve size, or between 45% by weight and 60% by weight is retained on a 325 mesh screen, U.S. Sieve size.

β-conglycinin-rich fractions which have been spray dried are typically in the form of a free-flowing powder having a bulk density from 0.20 to 0.30 g/cm³. These dried fractions typically have a particle size distribution such that between 5% by weight and 20% by weight of said powder is retained on a 200 mesh screen, U.S. Sieve size, and between 35% by weight and 60% by weight is retained on a 325 mesh screen, U.S. Sieve size.

Heat-treated and spray-dried fractions typically contain at least 85% by weight protein and, more typically, at least 92% by weight protein. Thus, protein fractions obtained in accordance with the process of the present invention are typically glycinin-rich or β-conglycinin-rich soy protein isolates.

The soy protein fractions of the present invention exhibit varying functionalities due to their varying protein contents. These fractions are suitable for use as functional food ingredients in a variety of food and beverage applications including, for example, meat products such as hot dogs and sausages, beverages such as soy milk and fruit juices, yogurts, and food bars. Generally, β-conglycinin-rich protein fractions are preferred for use in meat applications and certain beverage applications (e.g., soy milk).

The protein fractions of the present invention are capable of forming a gel in an aqueous solution due, at least in part, to the aggregation of the partially denatured proteins of the fractions. Substantial gel formation in an aqueous environment is a desirable quality of the fractions of the present invention since their gelling properties contribute to the texture and structure of meat products in which they are used. This quality of the fractions also provides a matrix for retaining moisture and fats in the meat products to enable a cooked meat product containing the unrefined soy protein material to retain its juices during cooking.

The protein fractions of the present invention are also capable of forming gels that have significant gel strength. Gel strength is a measure of the strength of a gel prepared by mixing a sample of soy material and water for a period of time sufficient to permit the formation of a gel. Gels having a 1:5 soy material:water ratio, by weight (including the moisture content of the soy material in the water weight) are prepared and used to fill a 3 piece 307×113 millimeter aluminum can which is sealed with a lid.

The gel strength may be determined generally for gels at room temperature (i.e., from 15° C. to 25° C.) and may also be measured for refrigerated gels (i.e., cold gel strength), pasteurized gels (i.e., pasteurized gel strength), and retorted gels (i.e., retorted gel strength). These various measurements relate to the suitability of the soy protein material in various applications.

To determine gel strength, a can containing the gel is opened and the gel is separated from the can. The strength of the gel is measured with an instrument which drives a probe into the gel until the gel breaks and measures the break point of the gel (preferably an Instron Universal Testing Instrument Model No. 1122 with 36 mm disk probe); and calculating the gel strength from the recorded break point of the gel. Gel strength may be measured for gels with and without salt, gels containing salt typically contain 2% by weight salt. Salt is generally used in the gel strength measurements when suitability of the soy protein material in food applications containing salt is of interest.
Gel strength is calculated according to the following formula:
Gel Strength (grams)=(F/100)(G)(454);
where F is the point of gel fracture, in chart units; 100 is the possible number of chart units; G is the full scale load dial reading times 10 (in pounds) of the instrument; and 454 is the number of grams per pound.

Gels consisting of a β-conglycinin-rich protein fraction and water at a 1:5 weight ratio typically have a gel strength of at least 8,000 grams, more typically at least 10,000 grams and, still more typically, at least 12,000 grams. Typically, such gels have a gel strength of from 12,000 grams to 16,000 grams and, more typically, from 14,000 grams to 16,000 grams. Gels consisting of a glycinin-rich fraction and water at a 1:5 weight ratio generally have a gel strength of less than 600 grams and, more generally, less than 500 grams. In certain embodiments, such gels have a gel strength of from 400 grams to 600 grams.

As an indicator of suitability for incorporation into food products containing salt, gel strength is also measured for a gel containing a protein fraction, water, and salt (for example, sodium chloride).

A gel consisting of a β-conglycinin-rich protein fraction and water at a 1:5 weight ratio and 2% by weight sodium chloride, typically has a gel strength of at least 8,000 grams and, more typically, at least 10,000 grams. Typically, such gels have a gel strength of from 10,000 grams to 14,000 grams and, more typically, from 12,000 grams to 13,000 grams.

Gels consisting of a glycinin-rich protein fraction and water at a 1:5 weight ratio and 2% by weight sodium chloride, generally have a gel strength of less than 1500 grams. Typically, such gels have a gel strength of from 1000 grams to 1500 grams.

Cold gel strength is a measure of the strength of a gel of a soy material following refrigeration immediately after preparation at −5° C. to 5° C. for a period of time (usually from 16 to 24 hours) sufficient for the gel to equilibrate to the refrigeration temperature. Thus, cold gel strength may provide an indication of suitability of the soy protein material for use in a product which will be refrigerated.

Refrigerated gels consisting of a β-conglycinin-rich protein fraction and water at a 1:5 weight ratio generally have a cold gel strength of at least 5000 grams. Typically, such gels have a cold gel strength of from 5000 grams to 7000 grams and, more typically, from 6000 grams to 7000 grams. Gels consisting of a glycinin-rich protein fraction and water at a 1:5 weight ratio generally have a cold gel strength of from 50 grams to 150 grams.

Cold gel strength is also determined for gels containing salt (e.g., sodium chloride). Gels consisting of a -conglycinin-rich protein fraction and water at a 1:5 weight ratio and 2% by weight sodium chloride generally have a cold gel strength of at least 5000 grams. Typically, such gels have a cold gel strength of from 5000 grams to 8000 grams, more typically, from 6000 grams to 8000 grams and, still more typically, from 7000 grams to 8000 grams. Gels consisting of a glycinin-rich protein fraction and water at a 1:5 weight ratio and 2% by weight sodium chloride generally have a cold gel strength of from 200 grams to 300 grams.

For pasteurized gel strength, cans containing the gel are placed in contact with boiling water for approximately 30 minutes, cooled with approximately 30° C. water, and then refrigerated at −5° C. to 5° C. for a period of time (usually from 16 to 24 hours) sufficient for the gel to equilibrate to the refrigeration temperature. Pasteurized gel strength generally may indicate the effect of heat treatment on the soy protein material.

Gels consisting of a β-conglycinin-rich protein fraction and water at a 1:5 weight ratio generally have a pasteurized gel strength of at least 10,000 grams and, more generally, at least 14,000 grams. Typically, such gels have a pasteurized gel strength of from 14,000 grams to 16,000 grams. Gels consisting of a β-conglycinin-rich protein fraction and water at a 1:6 weight ratio generally have a pasteurized gel strength of at least 13,500 grams. Gels consisting of a glycinin-rich protein fraction and water at a 1:5 weight ratio generally have a pasteurized gel strength of from 200 grams to 1000 grams.

Pasteurized gel strength is also determined for gels containing salt (e.g., sodium chloride). Gels consisting of a β-conglycinin-rich protein fraction and water at a 1:5 weight ratio and 2% by weight sodium chloride generally have a pasteurized gel strength of at least 8800 grams and, more generally, of at least 10,000 grams. Typically, such gels have a pasteurized gel strength of from 10,000 grams to 13,000 grams. Gels consisting of a β-conglycinin-rich protein fraction and water at a 1:6 weight ratio and 2% by weight sodium chloride generally have a pasteurized gel strength of at least 600 grams.

Gels consisting of a glycinin-rich protein fraction and water at a 1:5 weight ratio and 2% by weight sodium chloride generally have a pasteurized gel strength of from 250 grams to 1500 grams. Gels consisting of a glycinin-rich protein fraction and water at a 1:6 weight ratio and 2% by weight sodium chloride generally have a pasteurized gel strength of from 100 grams to 400 grams.

For retorted gel strength, cans containing the gel are placed into a retort chamber where the gels are processed at 110° C. (230° F.) for approximately 68 minutes using a 3 minute vent timer. Immediately after processing, the cans are cooled with approximately 30° C. water and refrigerated at −5° C. to 5° C. for a period of time (usually from 16 to 24 hours) sufficient for the gel to equilibrate to the refrigeration temperature. The higher temperatures used to determine the retorted gel strength may indicate suitability of the soy protein material for use in products to be stored at room temperature (i.e., condensed milk products) which generally requires treating the product at high temperatures to pasteurize and sterilize the product.

Gels consisting of a β-conglycinin-rich protein fraction and water at a 1:5 weight ratio generally have a retorted gel strength of at least 1000 grams and, more generally, from 1800 grams to 10,000 grams. Gels consisting of a glycinin-rich protein fraction and water at a 1:5 weight ratio generally have a retorted gel strength of from 200 grams to 300 grams.

Retorted gel strength is also determined for gels containing salt (e.g., sodium chloride). Gels consisting of a β-conglycinin-rich protein fraction and water at a 1:5 weight ratio and 2% by weight sodium chloride generally have a retorted gel strength of at least 3000 grams, more generally, from 3000 grams to 5000 grams and, still more generally, from 4000 grams to 5000 grams. Gels consisting of a glycinin-rich protein fraction and water at a 1:5 weight ratio and 2% by weight sodium chloride generally have a retorted gel strength of from 600 grams to 2500 grams.

For some food applications the ability of a soy protein material to form an emulsion and various features of such emulsions are important functional characteristics. Oil and water are not miscible and, in the absence of a material to stabilize the interface between them, the total surface area of the interface will be minimized. This typically leads to separate oil and water phases. Proteins can stabilize these interfaces by denaturing onto the surface providing a coating to a droplet (oil or water). The protein can interact with both the oil and the water and, in effect, insulate them from each other. Large molecular weight proteins are believed to be more able to denature onto such a droplet surface and provide greater stability than small proteins and thereby prevent droplet coalescence.

The texture, strength, and stability, of emulsions prepared using a protein fraction of the present invention may also be determined as an indicator of the suitability of the protein for use in applications containing water and oil components (e.g., various meat applications such as hot dogs).

An emulsion of a soy protein material to be evaluated is prepared by adding soybean oil (840 g 0.1 g) which has been equilibrated at 20°±3° C. to a beaker having a capacity of 1000 ml. The soybean oil is then introduced into the chopper bowl of a Hobart Food Cutter, Model# 84145, manufactured by the Hobart Corporation (Troy, Ohio) with the oil remaining in the beaker minimized by thoroughly scraping the surface of the beaker with a rubber spatula. The temperature of the food cutter bowl and lid is generally 20°±3° C.; this may be accomplished by rinsing the bowl and lid in cool tap water (e.g., at a temperature of from 15° C. to 25° C.) after cleaning and before emulsion preparation. Soy material sample (200.0 g 0.1 g) is introduced to the cutter bowl, quickly spreading the material over the entire surface of the oil. After the soy material sample is introduced to the oil, the food cutter lid is closed, the food cutter is started and timing begins. The time taken to add the soy material sample to the oil and start the food cutter is typically less than 15 seconds. Water (1,150 10 ml) at 20°±3° C. is measured in a 2 liter graduated cylinder. The water is introduced to the food cutter within 10 seconds after starting the food cutter. After one minute of chopping time has elapsed, the food cutter and timer are stopped. The lid of the food cutter is removed and thoroughly scraped with a rubber spatula. The lid is closed, the timer started, and chopping continues for four minutes. If desired, at five minutes total chopping time, salt (44.0 g 0.1 g) is added during one revolution of the bowl. Salt may be included in the emulsion characteristics for purposes of determining suitability of the soy protein materials in food applications containing salt (e.g., meat applications). At 5.5 minutes total chopping time, the food cutter and timer are stopped and the inside of the lid is thoroughly scraped. Chopping is resumed for an additional 1.5 minutes. At the end of seven minutes total chop time, the food cutter is stopped and a sample of the emulsion is obtained from the emulsion ring in the bowl (i.e., the sample is not taken from the side of the bowl or the lid of the cutter). The total elapsed time for emulsion preparation typically does not exceed 10 minutes.

A container which has a capacity of approximately 175 ml (6.0 ounces) is filled with the emulsion, taking care to pack it with no air pockets. The container has a height of 3.8 cm and diameter of 8 cm. The top of the cup is scraped with a stainless steel spatula leaving a smooth, even surface and the is allowed cup to stand undisturbed at room temperature for 5 minutes. The sample of emulsion in the cup is analyzed for its emulsion texture using a TA.TXT2 Texture Analyzer manufactured by Stable Micro Systems Ltd. (England). The gel tester speed control is set on the “fast” setting and the 21.5 mm probe is attached to the gel tester. The emulsion-containing cup is placed on the gel tester balance and positioned so that the probe will penetrate the surface of the emulsion approximately in the center of the cup, avoiding any irregularities in the surface. The balance is then tared and 5 minutes after the cup was filled, the “down” button on the gel tester is pressed to begin analysis. The display on the balance as the probe penetrates the emulsion is observed. The emulsion texture or, hardness, is the maximum force in grams observed on the balance before the probe automatically returns to the ready position.

Typically, an emulsion consisting of a protein fraction suitable for use in meat applications, oil, and water at a weight ratio of protein fraction to water of from 1:4 to 1:6 and a weight ratio of protein fraction to oil of from 1:4 to 1:5 exhibits an emulsion texture of at least 90 grams and, more typically, at least 110 grams.

An emulsion consisting of a β-conglycinin-rich protein fraction, oil, water at a weight ratio of protein fraction to water of from 1:4 to 1:6 and a weight ratio of protein fraction to oil of from 1:4 to 1:5, generally has an emulsion texture of at least 150 grams. Typically, such β-conglycinin-rich fractions have an emulsion texture of from 165 grams to 280 grams.

Three to four containers (e.g., an aluminum can having a capacity of 177 ml (6 oz) or a 205 ml (7 oz) plastic cup manufactured by Solo) are prepared as described above for measuring emulsion texture. The containers are inverted and placed onto a flat tray made from nonabsorbing material and covered with plastic film.

The samples in aluminum cans are kept in boiling water for approximately 30 minutes, chilled in an ice water bath for approximately 15 minutes, and refrigerated at 5 [symbol] 2□C for from 20 hours to 32 hours. Measurements obtained from these samples represent the “hot” emulsion strength of the sample.

Plastic containers are refrigerated at 5°±2° C. for from 16 hours to 32 hours. Measurements obtained from these samples represent the “cold” emulsion strength of the sample.

The sample of emulsion in the cup is analyzed for its emulsion strength using a TA.TXT2 Texture Analyzer manufactured by Stable Micro Systems Ltd. (England). The gel tester speed control is set to the “slow” setting and the 10.9 mm probe is attached to the gel tester. A container is removed from the refrigerator in such a way that the surface of the emulsion is not disturbed. If the surface of the emulsion is irregular, uneven, or damaged, the container is discarded and another container is removed for analysis. The container is placed on the gel tester balance and positioned such that the probe will penetrate the surface of the emulsion approximately in the center of the cup. The balance is tared and the “down” button on the gel tester is pressed to begin analysis. The balance on the display is observed as the probe penetrates the emulsion. The reading will increase to a maximum after which time the reading will remain constant or drop abruptly. The maximum reading is recorded, in grams, as the emulsion strength. The sample in a second container is analyzed as described. If the difference between the two readings is less than ten grams, the average of the two values is reported. If the difference between the two readings is ten grams or more, the samples in the remaining containers are analyzed and the average of the readings is reported.

Emulsion texture and strength both generally relate to the hardness or, firmness, of the emulsion. Such characteristics generally indicate the suitability of the protein fractions for incorporation into products (for example, meat applications) in which a firm product is desired.

An emulsion consisting of a protein fraction suitable for use in meat applications, oil, and water at a weight ratio of protein fraction to water of from 1:4 to 1:6 and a weight ratio of protein fraction to oil of from 1:4 to 1:5, generally exhibits an emulsion strength of at least 90 grams and, more typically, at least 110 grams.

An emulsion consisting of a β-conglycinin-rich protein fraction, oil, and water at a weight ratio of protein fraction to water of from 1:4 to 1:6 and a weight ratio of protein fraction to oil of from 1:4 to 1:5, typically exhibits a cold emulsion strength of from 120 to 185 grams and, more typically, from 160 to 180 grams.

An emulsion consisting of a β-conglycinin-rich protein fraction, oil, and water at a weight ratio of protein fraction to water of from 1:4 to 1:6 and a weight ratio of protein fraction to oil of from 1:4 to 1:5, typically exhibits a hot emulsion strength of from 180 to 340 grams and, more typically, from 180 to 315 grams.

To determine emulsion stability, three containers are prepared as described above for measuring emulsion texture (i.e., containing either hot or cold samples). The balance is tared to zero using a clean sheet of weighing paper. Two emulsion filled cups are removed from the refrigerator. The emulsion is carefully removed from each cup and cut in half longitudinally. Each half is placed on a sheet of weighing paper. If the sample weighs less than 85 grams, the sample is discarded and another is obtained. If the sample weighs from 85 g to 90 g the weight is recorded. If the sample weighs greater than 90 g, emulsion is removed from the uppermost curved side of the emulsion half to provide a sample weighing from 85 to 90 grams. The initial weight of the sample is recorded. Four halves of the emulsion sample from the refrigerated containers are evaluated. A cooking surface of a commercially available skillet (e.g., having a diameter of 12″ and depth of 2″) is prepared by lightly spraying with cooking spray and preheated at 70° C. for approximately 15 minutes. The emulsion halves are placed on the preheated skillet one at a time at 30 second intervals. The samples are fried at approximately 170° C. for 10 minutes. Each sample is weighed as it is removed from the skillet and its final weight is recorded. The skillet is cleaned before evaluating the next emulsion.

The emulsion stability is calculated as the percent weight loss of sample during cooking:
Emulsion Stability=(Initial Weight−Final Weight)/Initial Weight)×100%

Emulsion stability, as an indicator of moisture loss upon cooking (as the value increases, stability decreases), may be an important indicator of the suitability of the soy protein material for use in meat applications (e.g., hot dogs) in which moisture retention during cooking affects the mouthfeel of the product.

A cold sample emulsion consisting of a β-conglycinin-rich protein fraction, oil, and water at a weight ratio of protein fraction to water of from 1:4 to 1:6 and a weight ratio of protein fraction to oil of from 1:4 to 1:5, typically exhibits an emulsion stability of at least 2% and, more typically, from about 2 to 5%.

A hot sample emulsion consisting of a β-conglycinin-rich protein fraction, oil, and water at a weight ratio of protein fraction to water of from 1:4 to 1:6 and a weight ratio of protein fraction to oil of from 1:4 to 1:5, typically exhibits an emulsion stability of at least 4% and, more typically, from about 4 to 7%.

A cold sample emulsion consisting of a glycinin-rich protein fraction, oil, and water at a weight ratio of protein fraction to water of from 1:4 to 1:6 and a weight ratio of protein fraction to oil of from 1:4 to 1:5, typically exhibits an emulsion stability of at least 3% and, more typically, from about 3 to 4%.

A hot sample emulsion consisting of a glycinin-rich protein fraction, oil, and water at a weight ratio of protein fraction to water of from 1:4 to 1:6 and a weight ratio of protein fraction to oil of from 1:4 to 1:5, typically exhibits an emulsion stability of at least 3% and, more typically, from about 3 to 5%.

Emulsion capacity may be an important characteristic of a protein fraction to be incorporated into a food product containing water and oil components present as an emulsion. The protein fraction provides the interface of the oil and water of an emulsion. If the protein fraction does not have suitable emulsion capacity the components of the emulsion may separate; for example, in the case of a meat application in which the oil is not retained within the cohesive mass the product will not exhibit sufficient firmness or structure. The emulsion capacity of a soy protein material may be determined by preparing a 2% by weight solids dispersion of a soy protein material in water. Soybean oil is then added to the dispersion (25 g) at a rate of 10 ml/min to form an oil in water emulsion. Eventually, addition of the soybean oil will produce a water in oil emulsion (i.e., an emulsion inversion point is reached). The volume of oil added up to the emulsion inversion point is recorded and the emulsion capacity is calculated as the maximum amount of oil that could be emulsified by 1 gram of protein.

Aqueous dispersions consisting of 2% by weight of a protein fraction suitable for use in meat application, at a pH of 7, typically has an emulsion capacity of at least 400 grams oil/gram protein and, more typically, at least 600 grams oil/gram protein.

An aqueous dispersion consisting of 2% by weight of a β-conglycinin-rich protein fraction, at a pH of 7, generally has an emulsion capacity of at least 500 grams oil/gram protein. Typically, such a dispersion has an emulsion capacity of from 500 to 900 grams oil/gram protein, more typically from 600 to 900 grams oil/gram protein, still more typically from 700 to 900 grams oil/gram protein and, even more typically, from 800 to 900 grams oil/gram protein.

An aqueous dispersion consisting of 2% by weight of a glycinin-rich protein fraction, at a pH of 7, generally has an emulsion capacity of at least 400 grams oil/gram protein and, more generally, of from 400 to 600 grams oil/gram protein.

One important functionality characteristic of the proteins of the fractions of the present invention is their solubility in an aqueous solution, often expressed in terms of the nitrogen solubility index of the fraction. Fractions containing highly aqueous-soluble soy protein have a nitrogen solubility index of greater than 80%, while fractions containing large quantities of aqueous-insoluble soy protein have a nitrogen solubility index less than 25%.

Nitrogen Solubility Index (NSI) as used herein is defined as:
NSI=(% water soluble nitrogen of a protein containing sample/% total nitrogen in protein containing sample)×100

The nitrogen solubility index provides a measure of the percent of water soluble protein relative to total protein in a protein containing material. The nitrogen solubility index of a fraction of the present invention is measured in accordance with standard analytical methods, specifically A.O.C.S. Method Ba 11-65, which is incorporated herein by reference in its entirety. According to the Method Ba 11-65, a soy material sample (5 grams) ground fine enough so that at least 95% of the sample will pass through a U.S. grade 100 mesh screen (average particle size of less than 150 microns) is suspended in distilled water (200 ml), with stirring at 120 rpm, at 30° C. for two hours; the sample is then diluted to 250 milliliters with additional distilled water. If the soy material is a full-fat material the sample need only be ground fine enough so that at least 80% of the material will pass through a U.S. grade 80 mesh screen (approximately 175 μm), and 90% will pass through a U.S. grade 60 mesh screen (approximately 205 μm). Dry ice is typically added to the soy material sample during grinding to prevent denaturation of sample. Sample extract (40 ml) is decanted and centrifuged for 10 minutes at 1500 rpm, and an aliquot of the supernatant is analyzed for Kjeldahl protein (PRKR) to determine the percent of water soluble nitrogen in the soy material sample according to A.O.C.S Official Methods Bc 4-91 (1997), Ba 4d-90, or Aa 5-91, hereby incorporated by reference in their entirety. A separate portion of the soy material sample is analyzed for total protein by the PRKR method to determine the total nitrogen in the sample. The resulting values of Percent Water Soluble Nitrogen and Percent Total Nitrogen are utilized in the formula above to calculate the nitrogen solubility index. Depending on the intended application of the soy protein material, the solubility of the soy protein materials at various pH values may also be of interest. The percent of soluble protein is determined as described above except the sample extract (40 ml) is decanted and centrifuged for 10 minutes at 1000 rpm. The solubility of the soy protein material may be determined for a wide pH range, for example, over a range of from 2 to 10.

Protein fractions of the present invention containing from 40% to 75% or from 40% to 80% β-conglycinin (i.e., β-conglycinin-rich fractions) generally, at pH 7, have a nitrogen solubility index of at least 70% and, more generally, at least 80%. Typically, such fractions have a nitrogen solubility index of from 90% to 95%.

Protein fractions of the present invention containing from 50% to 95% glycinin (i.e., glycinin-rich fractions) generally have a nitrogen solubility index of less than 80% and, more generally, from 60% to 80%, at pH 7. Such fractions generally have a nitrogen solubility index of less than 40% at pH from 3 to 6.

The solubility of the protein fractions affects whether the fractions are preferred for incorporation in certain food products. For example, highly soluble fractions are preferred for use in beverage applications to avoid formation of a precipitate which is generally undesired by consumers. Thus, in the case of beverage applications, preferably the soy protein fraction has a nitrogen solubility index of at least 65% and, more preferably, from 75% to 90%.

The protein fractions of the present invention retain their solubility in aqueous media containing salt (for example, sodium chloride). This is an important feature of the protein fractions of the present invention since they may be used as functional food ingredients in food products containing significant amounts of salt (e.g., emulsified meats or soups). Such solubilities are typically expressed in terms of the salt tolerance index which may be determined using the following method. Sodium chloride (0.75 grams) is weighed and added to a 400 ml beaker. Water (150 ml) at 30°±1° C. is added to the beaker, and the salt is dissolved completely in the water. The salt solution is added to a mixing chamber, and a sample of a soy material (5 grams) is added to the salt solution in the mixing chamber. The sample and salt solution are blended for 5 minutes at 7000 revolutions per minute (rpm) ±200 rpm. The resulting slurry is transferred to a 400 milliliter beaker, and water (50 ml) is used to rinse the mixing chamber. The 50 ml rinse is added to the slurry and the beaker containing the slurry is placed in 30° C. water bath and is stirred at 120 rpm for a period of 60 minutes. The contents of the beaker are then quantitatively transferred to a 250 ml volumetric flask using deionized water. The slurry is diluted to 250 milliliters with deionized water, and the contents of the flask are mixed thoroughly by inverting the flask several times. A sample of the slurry (45 ml) is transferred to a 50 milliliter centrifuge tube and the slurry is centrifuged for 10 minutes at 500 times the gravitational constant. The supernatant is filtered from the centrifuge tube through filter paper into a 100 milliliter beaker. Protein content analysis is then performed on the filtrate and on the original dry soy material sample according to A.O.C.S Official Methods Bc 4-91 (1997), Ba 4d-90, or Aa 5-91, hereby incorporated by reference in their entirety.

The salt tolerance index (STI) is calculated according to the following formula:
STI (%)=(100)*(50)*(P_{f}/P_{d})
P_{f} represents the Percent Soluble Protein in the filtrate while P_{d} represents the Percent Total Protein in the dry soy material sample.

β-conglycinin-rich protein fractions of the present invention generally have a salt tolerance index (i.e., nitrogen solubility index measured in the presence of salt) of at least 70% and, more generally, at least 75%. Typically, such fractions have a salt tolerance index of from 75% to 85%. Glycinin-rich protein fractions of the present invention generally have a salt tolerance index of less than 65% and, more generally, less than 62%. Preferably, protein fractions used in emulsified meat applications have a salt tolerance index, at pH 7, of at least 45% and, more preferably, 70%.

Whiteness index is one measure of the appearance of soy protein-containing material and compositions. In general, the whiteness index is determined using a colorimeter which provides the L, a, and b color values for the composition from which the whiteness index may be calculated using a standard expression of the Whiteness Index (WI), WI=L−3b. The L component generally indicates the “lightness” of the sample; L values near 0 indicate a black sample while L values near 100 indicate a white sample. The b value indicates yellow and blue colors present in the sample; positive b values indicate the presence of yellow colors while negative b values indicate the presence of blue colors. The a value, which may be used in other color measurements, indicates red and green colors; positive values indicate the presence of red colors while negative values indicate the presence of green colors. For the b and a values, the absolute value of the measurement increases directly as the intensity of the corresponding color increases. Generally, the colorimeter is standardized using a white standard tile provided with the colorimeter. A sample is then placed into a glass cell which is introduced to the colorimeter. The sample cell is covered with an opaque cover to minimize the possibility of ambient light reaching the detector through the sample and serves as a constant during measurement of the sample. After the reading is taken, the sample cell is emptied and typically refilled as multiple samples of the same material are generally measured and the whiteness index of the material expressed as the average of the measurements. Suitable calorimeters generally include those manufactured by HunterLab (Reston, Va.) including, for example, Model # DP-9000 with Optical Sensor D 25.

Aqueous dispersions containing from 4% to 6% (generally, 5% by weight) of a β-conglycinin-rich protein fraction of the present invention, at a pH of 7, typically have a whiteness index of at least 20, more typically from 20 to 45 and, still more typically, from 25 to 45. A powder of such a protein fraction, which has a moisture content of 5% by weight, generally has a whiteness index of from 50 to 60.

Aqueous dispersions containing from 4% to 6% (generally, 5% by weight) of a glycinin-rich protein fraction of the present invention, at a pH of 7, generally have a whiteness index of at least 40 and, more generally, from 40 to 50. A powder of such a protein fraction, which has a moisture content of 5% by weight, generally has a whiteness index of from 50 to 60.

As described above, β-conglycinin-rich fractions are generally preferred for use in beverage applications including, for example, soy milk products based on their favorable solubilities. Generally, as the glycinin content of a β-conglycinin-rich protein fraction increases, the whiteness index of a dispersion of the fraction increases. Higher whiteness indices (for example, from 30 to 40) are generally preferred for milk applications; thus β-conglycinin-rich protein fractions having high glycinin contents (for example, from 15% to 20%) are generally preferred for use in milk products. However, for other beverage applications (e.g., fruit juice), such fractions are generally undesired. Thus, β-conglycinin-rich protein fractions having lower glycinin contents (for example, from 10% to 15%) are generally preferred for non-soy milk beverage applications.

In the case of meat applications, lower whiteness indices (for example, from 15 to 20) are preferred to minimize the effect of the fraction on the visual properties of the product. Thus, β-conglycinin-rich protein fractions having lower glycinin contents (for example, less than 15%) are generally preferred for incorporation in meat products.

Viscosities of protein fractions in an aqueous medium generally vary depending on the protein content of the fraction, relative glycinin and β-conglycinin content, pH of the sample, temperature, and presence of salt (typically 2% by weight sodium chloride) in the sample.

Higher viscosity characteristics of the fractions in an aqueous medium promote and are associated with gel formation. Thus, fractions exhibiting higher viscosities in aqueous media are generally are desirable for use in meat applications. Such high viscosity of a fraction is believed to be due, at least in part, to the aggregation of the partially denatured soy protein of the fraction and its water hydration capacity. Higher viscosity of the fraction in an aqueous medium also enables the fraction to be utilized as a thickening agent in gravies, yogurts, and soups, especially creamed soups, and to be used in baking applications. Protein fractions exhibiting lower viscosity in an aqueous medium are generally preferred when the fractions are to be incorporated into beverages. If the viscosity of such a protein fraction is too high, a precipitate will form, thus adversely affecting the desirability of such a beverage from a consumer's perspective.

Viscosity refers to the apparent viscosity of a slurry or a solution as measured with a rotating spindle viscometer utilizing a large annulus, where a particularly preferred rotating spindle viscometer is a Brookfield viscometer. The apparent viscosity of a soy material is measured by weighing a sample of the soy material and water to obtain a known ratio of the soy material to water (preferably 1 part soy material to 7 parts water, by weight), combining and mixing the soy material and water in a blender or mixer to form a homogenous slurry of the soy material and water at a temperature of 20° C. and pH of 7, and measuring the apparent viscosity of the slurry with the rotating spindle viscometer utilizing a large annulus, operated at approximately 30 to 60 revolutions per minute (rpm) and at a torque of from 30 to 70%. The desired viscosity of a dispersion of a protein fraction of the present invention depends on the intended application.

Typically, the viscosity of a 7% by weight dispersion of a β-conglycinin-rich protein fraction in an aqueous medium at pH 5.6 at 20° C. has a viscosity of from 20 to 225 centipoise and, still more typically, from 40 to 120 centipoise.

The presence of salt may affect the viscosity of a sample of a β-conglycinin-rich protein fraction of the present invention. The viscosity of dispersions containing a β-conglycinin-rich protein fraction of the present invention containing salt (e.g., sodium chloride) is a useful measurement as many applications in which the fractions are incorporated contain significant amounts of salt. Typically, the viscosity of a 7% by weight dispersion of a β-conglycinin-rich protein fraction in an aqueous medium at pH 5.6 at 20° C. containing 2% by weight sodium chloride has a viscosity of less than 200 centipoise. Generally, the viscosity of such a sample is from 20 to 200 centipoise and, more generally, from 20 to 125 centipoise.

Typically, the viscosity of a 7% by weight dispersion of a β-conglycinin-rich protein fraction in an aqueous medium at pH 7.0 to 7.2 and 20° C., regardless of the presence of 2% by weight sodium chloride, has a viscosity of less than 30 centipoise. Similarly, the viscosity of a 7% by weight dispersion of a β-conglycinin-rich protein fraction in an aqueous medium at pH 6.9 to 7.1 and 20° C., regardless of the presence of 2% by weight sodium chloride, has a viscosity of less than 25 centipoise.

Typically, the viscosity of a 7% by weight dispersion of a glycinin-rich protein fraction in an aqueous medium at pH 5.6 at 20° C. has a viscosity of less than 225 centipoise. In certain embodiments, the viscosity of such a sample is from 50 to 120 centipoise and, in other embodiments, the viscosity is from 120 to 225 centipoise.

The presence of salt may affect the viscosity of a sample of a glycinin-rich protein fraction of the present invention. Typically, the viscosity of a 7% by weight dispersion of a glycinin-rich protein fraction in an aqueous medium at pH 5.6 at 20° C. containing 2% by weight sodium chloride has a viscosity of less than 50 centipoise, more typically less than 25 centipoise and, still more typically, less than 20 centipoise.

Typically, the viscosity of a 7% by weight dispersion of a glycinin-rich protein fraction in an aqueous medium at pH 7.0 to 7.2 and 20° C., regardless of the presence of 2% by weight sodium chloride, has a viscosity of less than 25 centipoise. Similarly, the viscosity of a 7% by weight dispersion of a glycinin-rich protein fraction in an aqueous medium at pH 6.9 to 7.1 and 20° C., regardless of the presence of 2% by weight sodium chloride, has a viscosity of less than 25 centipoise.

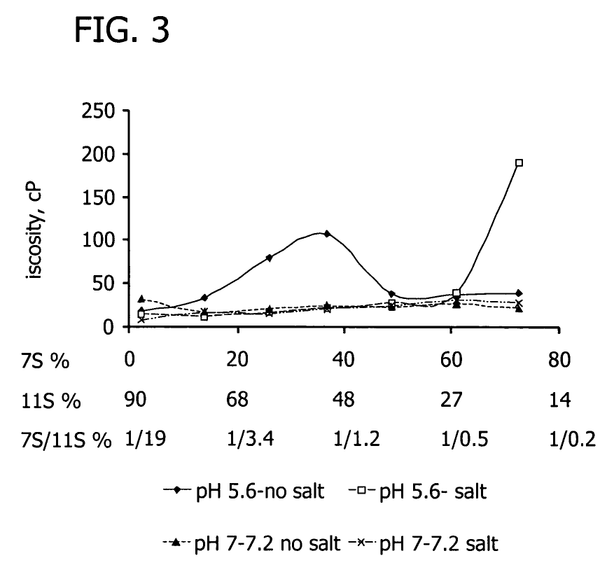

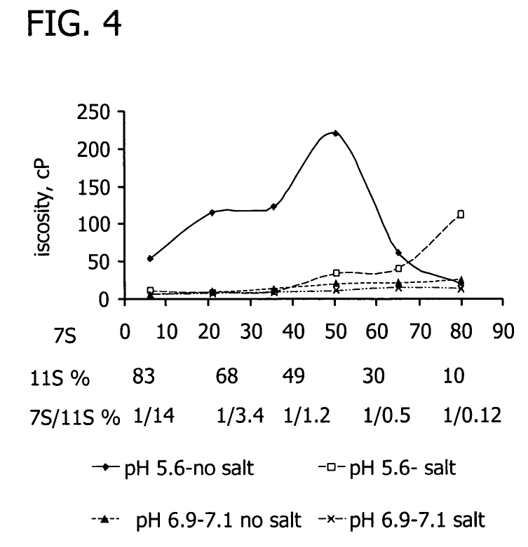

As shown in FIGS. 3 and 4, viscosities of 7% by weight dispersions of β-conglycinin-rich and glycinin-rich protein fractions in an aqueous medium, at pH 7.0 to 7.2 or 5.6, at 20° C. and with and without 2% by weight sodium chloride, vary depending on the relative β-conglycinin/glycinin content of the fraction.

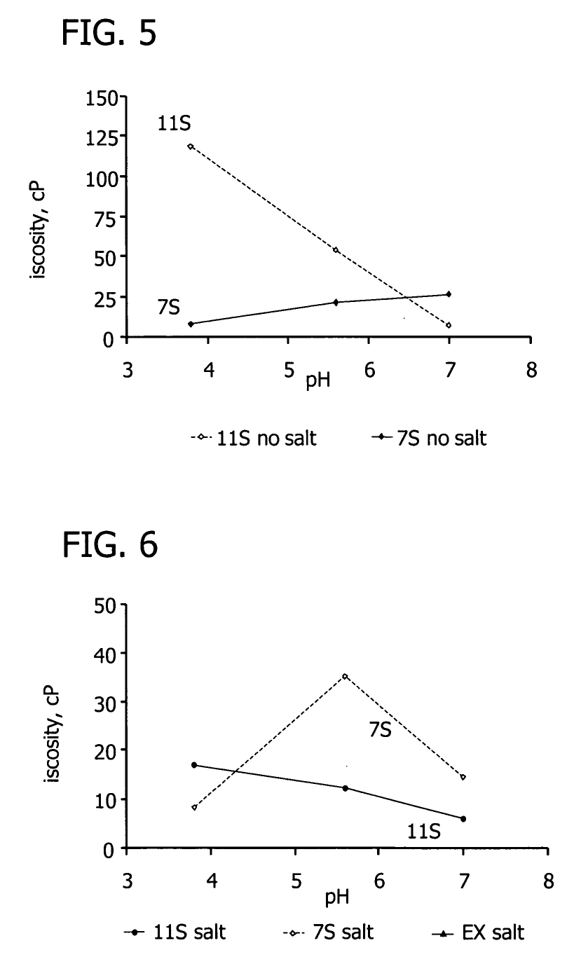

As shown in FIG. 5, the viscosity of a 7% by weight dispersion of a β-conglycinin-rich protein fraction in an aqueous medium at pH 7.0 to 7.2 and 20° C., in the absence of sodium chloride, generally increases with increasing pH. Also shown in FIG. 5, the viscosity of a 7% by weight dispersion of a glycinin-rich protein fraction in an aqueous medium at pH 7.0 to 7.2 and 20° C., in the absence of sodium chloride, generally decreases with increasing pH.

As shown in FIG. 6, in certain embodiments, the viscosity of a 7% by weight dispersion of a -conglycinin-rich protein fraction in an aqueous medium at pH 7.0 to 7.2 at 20° C. and containing 2% by weight sodium chloride, increases with increasing pH to a certain pH (as shown in FIG. 6, approximately pH 5.5) and then decreases with increasing pH. Also shown in FIG. 6, the viscosity of a 7% by weight dispersion of a glycinin-rich protein fraction in an aqueous medium at pH 7.0 to 7.2 at 20° C. containing 2% by weight sodium chloride generally decreases with increasing pH.

The translucency of an aqueous dispersion of a protein fraction of the present invention, indicated by the percentage of light at certain wavelengths passing through the dispersion (i.e., percent transmittance), may be an important functional characteristic depending on the intended application.

A sample of soy protein material (20 grams) is placed in an inverted frustoconical container having a capacity of approximately 205 ml (for example, a 7 ounce plastic cup manufactured by Solo). Water (180 ml) is introduced into a small blender jar and the sample is slowly added to the water in the blender jar of a blender (e.g., Osterizer blender) to avoid sample loss. The blade assembly is attached to the blender jar and the mixture is blended on the lowest setting for 30 seconds. If undispersed sample is present, a small spatula is used to disperse it into the slurry. The lid of the blender jar is replaced and the slurry mixed for an additional 5 seconds on the lowest speed. The sample is removed from the blender jar and placed into an inverted frustoconical container described above which is covered and left undisturbed for 60 minutes. The slurry is then stirred and a sample of the slurry (45 ml) is transferred to a 50 ml Nalgene centrifuge tube and the lid of the tube is secured. The centrifuge tube is placed into a water bath that has been pre-heated to 97° C. and left for 45 minutes. Up to three samples may be analyzed at once, in which case the samples are introduced to the water bath at 5 minute intervals. While the samples are being heated, translucent microscope slides (Fisherbrand, Colorfrost) are labeled with sample information and a rubber gasket is placed on the bottom of an unlabeled slide. The hot sample is added to the gasket using a disposable pipette and the side is lowered slowly to avoid trapping air. The samples are then allowed to cool for at least 1 hour. Dried product or excess moisture is removed from the slide assembly. The samples are analyzed using a Backman spectrophotometer (DU640). The samples are typically analyzed at wavelengths of 400 nm and 800 nm. Absorbance of the sample may be measured in the same manner using the spectrophotometer and the results are recorded. The desired transmittance or absorbance (i.e., relative amounts of light passing through or absorbed by a dispersion of a protein fraction) generally depends on the intended application.

Typically, an aqueous dispersion consisting of 10% by weight of a β-conglycinin-rich protein fraction exhibits a percent transmittance at 800 nanometers (nm) of at least 60%. More typically, such a dispersion exhibits a percent transmittance at 800 nm of at least 70%, more typically from 70% to 95% and, still more typically, from 80% to 95%.

It has been observed that as the glycinin content of β-conglycinin-rich fractions increases, the percent transmittance may decrease (i.e., the opaqueness of an aqueous dispersion of such a fraction increases). In certain applications including, for example, meat applications and beverage applications such as fruit juice, a fraction which may contribute opaqueness to the product is undesired based on its adverse effect on the visual properties of such products. Thus, in certain instances, β-conglycinin-rich fractions having relatively low glycinin contents (e.g., from 10% to 15%) are preferred for these types of products. However, in other applications including, for example, milk products, an opaque appearance may be preferred. Thus, β-conglycinin-rich fractions having higher glycinin contents (e.g., from 15% to 20%) are preferred for these types of products.

Typically, an aqueous dispersion consisting of 10% by weight of a glycinin-rich protein fraction exhibits a percent transmittance at 800 nanometers (nm) of less than 10%.

Food products containing protein fractions are described below in certain examples (e.g., meat products, yogurt). In addition to functionality, incorporating the protein fractions of the present invention generally provide a low-cost source of protein. For example, in certain meat applications, relatively expensive ingredients such as egg albumin can be omitted and a higher content of protein ingredient (e.g., β-conglycinin-rich fraction) included.

The present invention is illustrated by the following examples which are merely for the purpose of illustration and not to be regarded as limiting the scope of the invention or manner in which it may be practiced.

### EXAMPLE 1

This example demonstrates preparing glycinin-rich and β-conglycinin-rich fractions from a soy protein extract solution using various amounts of calcium chloride. Various amounts of calcium chloride are added to an extract solution containing soy protein in four separate precipitations.

For each of the four separate precipitations, the soy protein extract solution is prepared by contacting a mixture of defatted commodity white soybean flakes produced by Cargill, Inc. (Minneapolis, Minn.) and water (10:1 weight ratio of water to flakes) with calcium hydroxide at a pH of 9.7 and a temperature of 32° C. (90° F.) for 15 minutes. The soybean flakes contain 50% by weight protein. The flakes contain from 10-15% β-conglycinin and from 40-55% glycinin, on a total protein basis.

Sodium bisulfite (0.5 g, 0.2 g/l) is added to the extract solution. In each run, hydrochloric acid (1.0 M) is added to the solution to adjust the pH to 7.5 and calcium chloride is added to the extract solution at pH of 7.5 as follows:
Precipitation 1—1.0 g CaCl₂ per liter of extract solution
Precipitation 2—2.0 g CaCl₂ per liter of extract solution
Precipitation 3—4.0 g CaCl₂ per liter of extract solution
Precipitation 4—6.0 g CaCl₂ per liter of extract solution

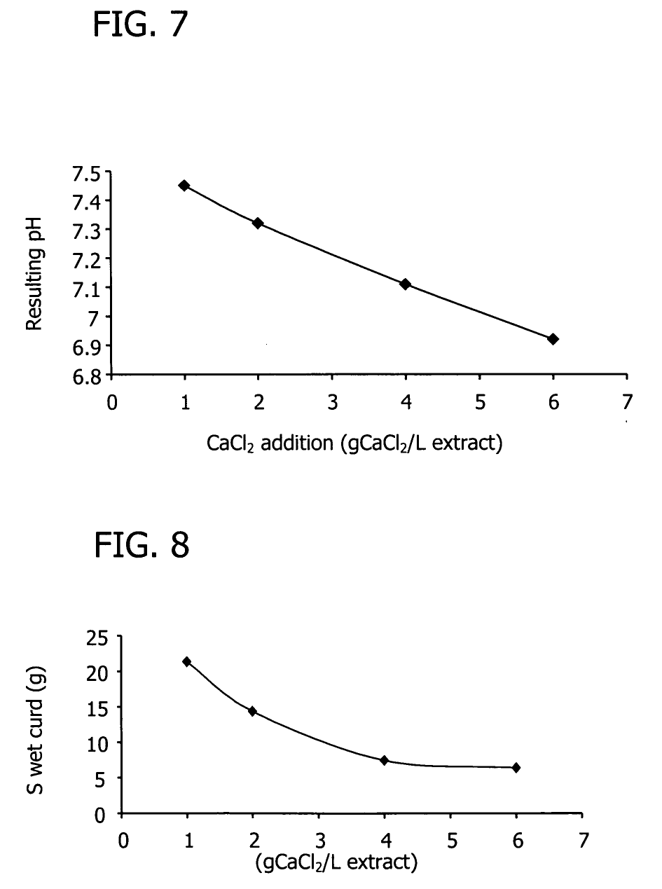

FIG. 7 shows the effect of addition of CaCl₂ to the extract solution on its pH. As shown in FIG. 7, extract pH decreases as addition of CaCl₂ increases.

Adjustment of the pH to 7.5 and addition of calcium produce a glycinin-rich precipitate which is separated from the supernatant by centrifuging at 3660 rpm in a Sharples 3400 decanting centrifuge available from Alfa Laval Separation Inc. (Warminster, Pa.) to produce a glycinin-rich fraction.

The pH of the supernatant is then adjusted to 4.8 by the addition of hydrochloric acid (1.0 M) to precipitate a fraction rich in β-conglycinin. The β-conglycinin fraction is also separated and recovered by centrifugation as described above and weighed.

FIG. 8 shows the effect of addition of CaCl₂ to the extract on the amount of β-conglycinin-rich fraction recovered. As shown in FIG. 8, the amount of β-conglycinin-rich fraction recovered decreases with increasing addition of CaCl₂.

The glycinin-rich and β-conglycinin-rich fractions are analyzed by sodium dodecyl sulfate-polyacrylamide gel electrophoresis (SDS-PAGE) to determine the protein contents of the fractions.

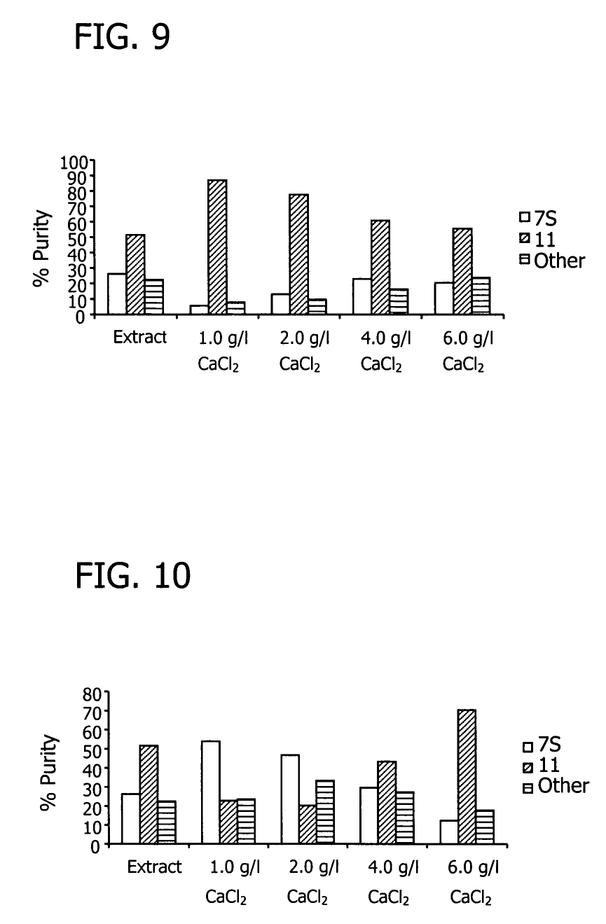

FIGS. 9 and 10 show the relative glycinin and β-conglycinin contents of the glycinin-rich fraction and the β-conglycinin-rich fractions, respectively. As shown in the figures, glycinin and -conglycinin purity increases as the amount of CaCl₂ introduced to the extract increases.

### EXAMPLE 2

This example demonstrates the influence of pH when preparing glycinin-rich and β-conglycinin-rich fractions from a soy protein extract solution to which calcium chloride is introduced as described above in Example 1.

The pH of an extraction solution prepared as described above in Example 1 is adjusted to enhance precipitation of a glycinin-rich fraction therefrom.

Sodium bisulfite (0.5 g/l extract solution) is added and the pH is adjusted by adding hydrochloric acid (1.0 M) in five separate runs during which the pH is adjusted to 7.5, 7.0, 6.5, 6.0, and 5.5, respectively.

Calcium chloride (1.0 g/L extract solution) is added to each of the extraction solutions after its pH is adjusted to the desired level. A glycinin-rich precipitate is separated from the supernatant by centrifugation as described above in Example 1. The pH of the supernatant is then adjusted to 4.8 by the addition of hydrochloric acid (1.0 M) to precipitate a fraction rich in β-conglycinin. The β-conglycinin fraction is also separated and recovered by centrifugation as described above in Example 1.

Each of the fractions is weighed and analyzed by sodium dodecyl sulfate-polyacrylamide gel electrophoresis (SDS-PAGE) to determine the protein contents of the fractions.

Table 1 shows the appearance of the glycinin-rich and β-conglycinin-rich fractions, supernatants, and the weight of extract at various pH levels.

TABLE 1

| pH of CaCl₂ | Treated Extract | 11S | Supernatant | |
|---|---|---|---|---|
| addition | Appearance | solids (g) | turbidity | 7S solids (g) |
| 7.5 | off-white | 6.55 | very cloudy | 8.90 |
| 7.0 | | 7.13 | cloudy | 7.06 |
| 6.5 | whiter | 8.79 | less cloudy | 5.48 |
| 6.0 | | 11.53 | clear (yellow) | 2.95 |
| 5.5 | whitest | 11.87 | clear (yellow) | 1.53 |

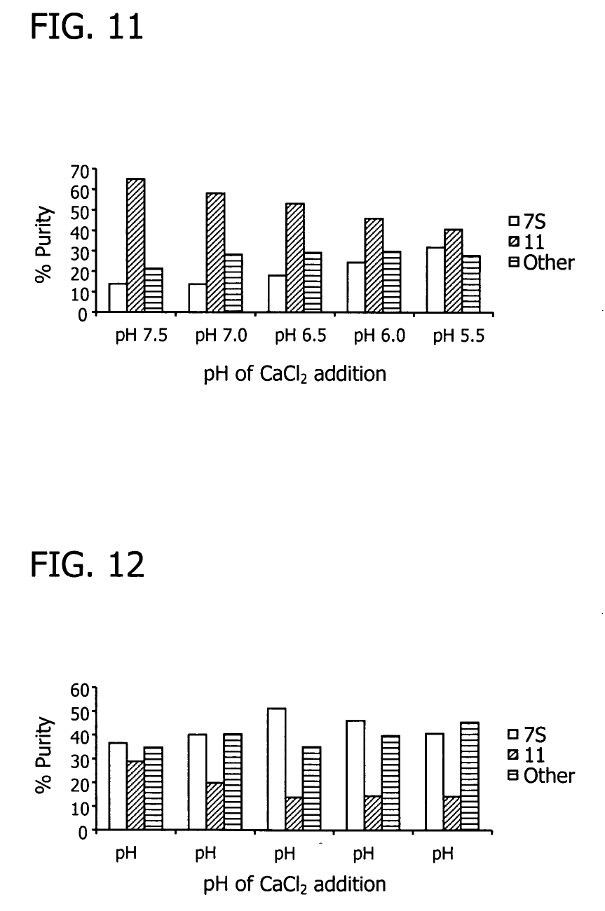

FIGS. 11 and 12 show the relative glycinin and β-conglycinin contents of the glycinin-rich fraction and the β-conglycinin-rich fractions, respectively. As shown in FIG. 11, purity of the glycinin-rich fraction decreases with decreasing pH of CaCl₂ addition. As shown in FIG. 12, purity of the β-conglycinin-rich fraction is highest at CaCl₂ addition pH of 6.5

### EXAMPLE 3

This example demonstrates the effect of addition of sodium bisulfite as a reducing agent when preparing glycinin-rich and β-conglycinin-rich fractions from a soy protein extract solution prepared as described above in Example 1.

Five precipitation runs, varying only in the amount of sodium bisulfite added to the extraction solution before precipitation of the glycinin-rich fraction, are carried out. The amounts of sodium bisulfite added to the extracts for each run are 0.1 g/l extract, 0.2 g/l extract, 0.3 g/l extract, 0.4 g/l extract, and 0.5 g/l extract. During each run, the respective amount of sodium bisulfite is added to the extract at pH 9.7.

Calcium chloride (1 g/l extract) is added to the extraction solution to precipitate a glycinin-rich fraction. The pH of the extract solution is then adjusted to 6.2 by addition of hydrochloric acid (1.0 M) for glycinin precipitation and a glycinin-rich precipitate is separated from the supernatant by centrifugation as described above in Example 1. The pH of the supernatant is then adjusted to 4.8 by the addition of hydrochloric acid (1.0 M) to precipitate a fraction rich in β-conglycinin. The β-conglycinin fraction is also separated and recovered by centrifugation as described above in Example 1.

Each of the fractions is weighed and analyzed by sodium dodecyl sulfate-polyacrylamide gel electrophoresis (SDS-PAGE) to determine the protein contents of the fractions.

Table 2 shows the appearance of the glycinin-rich and β-conglycinin-rich fractions, supernatants, and the weight of extract at various pH levels.

TABLE 2

| G NaHSo₃/liter | Supernatant | 11S | | |
|---|---|---|---|---|
| extract | turbidity | solids (g) | Supernatant | 7S solids (g) |
| 0.1 | hardest | 11.39 | milky | 2.53 |
| 0.2 | | 11.65 | | 3.01 |
| 0.4 | | 11.06 | milky | 2.83 |
| 0.5 | | 11.15 | | 2.83 |
| 0.6 | loosest | 10.65 | white | 2.33 |

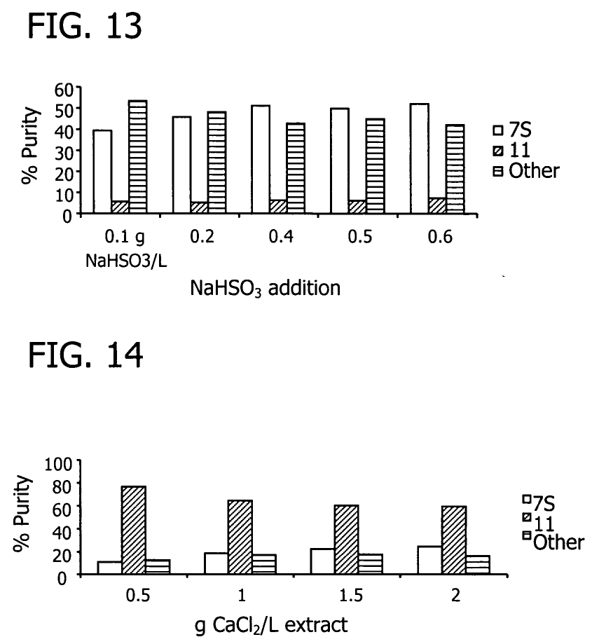

FIG. 13 shows the relative glycinin and β-conglycinin contents of the β-conglycinin-rich fractions over the course of the various runs.

### EXAMPLE 4

This example demonstrates preparing glycinin-rich and -conglycinin-rich fractions from a soy protein extract solution using various amounts of calcium chloride to enhance the precipitation of the glycinin-rich fraction during 4 precipitation runs.

A soy protein extract solution is prepared by contacting a mixture of defatted commodity white soybean flakes produced by Cargill, Inc. (Minneapolis, Minn.) and water (10:1 weight ratio of water to flakes) with calcium hydroxide at a pH of 8.5 and a temperature of 32° C. (90° F.) for 15 minutes. The soybean flakes contain 50% by weight protein. The flakes contain from 10-15% β-conglycinin and from 40-55% glycinin, on a total protein basis.

Sodium bisulfite (0.2 g/l) is added to the extract solution. Hydrochloric acid (1.0 M) is added to the solution to adjust the pH to 7.5.

In each of the four runs, calcium chloride is added to the extract solution at a pH of 7.5 as follows:
Run 1—0.5 g CaCl₂ per liter of extract solution
Run 2—1.0 g CaCl₂ per liter of extract solution
Run 3—1.5 g CaCl₂ per liter of extract solution
Run 4—2.0 g CaCl₂ per liter of extract solution

After the addition of calcium chloride, the extract solution has a pH of 6.5 and contains precipitated glycinin. The precipitated glycinin-rich fraction is separated and centrifuged as described above in Example 1.

The supernatant is then adjusted to pH 4.7 by the addition of hydrochloric acid (1.0 M) wherein a fraction rich in β-conglycinin is precipitated. The β-conglycinin fraction is then separated and recovered by centrifugation.

Each of the fractions is weighed and analyzed by sodium dodecyl sulfate-polyacrylamide gel electrophoresis (SDS-PAGE) analysis as described above to determine the protein contents of the fractions.

Table 3 shows the appearance of the glycinin-rich and β-conglycinin-rich fractions, supernatants, and the weight of extract at the various levels of calcium chloride addition.

TABLE 3

| | Supernatant | 11S curd | | |
|---|---|---|---|---|
| CaCl₂ (g/l) | turbidity | appearance | 11S solids (g) | 7S solids (g) |
| 0.5 | milky/cloudy | loosest | 8.70 | 7.55 |
| 1.0 | murky | looser | 14.2 | 3.87 |
| 1.5 | clear | loose | 12.5 | 2.97 |
| 2.0 | clear | firm | 15.4 | 2.62 |

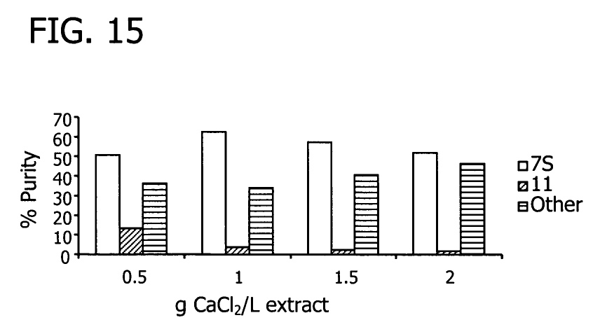

FIGS. 14 and 15 show the relative glycinin and β-conglycinin contents of the glycinin-rich fraction and the -conglycinin-rich fractions, respectively.

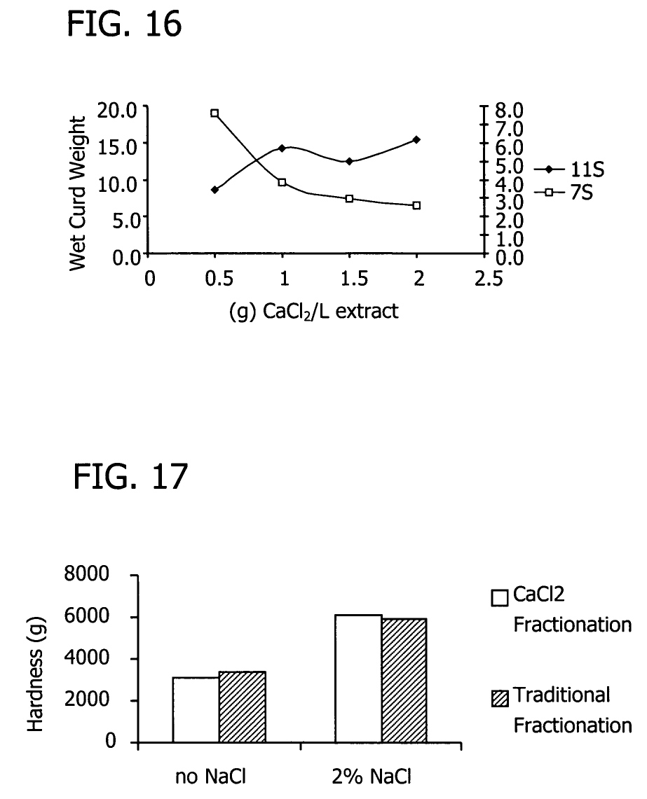

FIG. 16 shows the relationship between amount of calcium chloride addition and protein precipitation in the two fractions.

### EXAMPLE 5

A soy protein extract is prepared by contacting a mixture of defatted commodity white soybean flakes produced by Cargill, Inc. (Minneapolis, Minn.) and water (10:1 weight ratio of water to flakes) with calcium hydroxide at a pH of 9.7 and a temperature of 32° C. (90° F.) for 30 minutes. The soybean flakes contain 50% by weight protein. The flakes contain from 10-15% β-conglycinin and from 40-55% glycinin, on a total protein basis.

Sodium bisulfite (0.2 g/l extract) is added to the extract solution. Hydrochloric acid (1.0 M) is added to the solution to adjust the pH to 6.25.

Calcium chloride (0.2 g/l extract) is added to the dispersion at a pH of 6.25 to precipitate a glycinin-rich fraction. Precipitated glycinin is separated by centrifuging as described above in Example 1.

The supernatant is then adjusted to pH 4.7 by the addition of hydrochloric acid (1.0 M) wherein a fraction rich in -conglycinin is precipitated from the extract. The β-conglycinin-rich fraction is separated by centrifuging as described above in Example 1. The β-conglycinin-rich fraction is pasteurized for 2 minutes at 95° C. and spray-dried.

For comparison purposes, a glycinin-rich and β-conglycinin-rich fraction are fractionated from a soy protein extract prepared as described above at pH 5.2 and 4.7, respectively, without addition of sodium bisulfite or calcium chloride.

Gels consisting of each of the heat treated (i.e., pasteurized) fractions prepared in accordance with the present example and water at a 1:5 weight ratio are prepared and analyzed to determine their pasteurized gel strength in accordance with the above-described protocol using a TA.TXT2 texture analyzer (Stable Micro Systems, Ltd., England).

Gels consisting of each of the fractions prepared in accordance with the present example and water at a 1:5 weight ratio and 2% by weight sodium chloride are also prepared and analyzed to determine their pasteurized gel strength in accordance with the above-described protocol using a TA.TXT2 texture analyzer (Stable Micro Systems, Ltd., England).

FIG. 17 shows the pasteurized gel strengths for gels containing a glycinin-rich and β-conglycinin-rich fraction fractionated using CaCl₂ in accordance with the present example (with and without sodium chloride present in the gels) and a glycinin-rich fraction and a β-conglycinin-rich fractions fractionated without CaCl₂ addition (with and without sodium chloride present in the gels).

### EXAMPLE 6

The following example describes preparing a meat product incorporating a β-conglycinin-rich soy protein isolate prepared in accordance with the present process into the European Emulsified Meat Model and functional properties of the product. Products containing β-conglycinin-rich isolates of varying β-conglycinin content (60%, 70%, and 80%) and Supro EX33 soy protein isolate available from the Solae Company (St. Louis, Mo.) are prepared.

The products contain the ingredients listed in Table 4:

TABLE 4

| Ingredients | Percent, by weight |
|---|---|
| Pork Shoulder (80% lean) | 20.00 |
| Pork Backfat | 15.00 |
| Mechanically deboned chicken | 20.00 |
| Potato Starch | 2.00 |
| Skin Emulsion (1:1) | 10.00 |
| Functional Protein | 3.50 |
| Salt | 1.70 |
| Sodium Tripolyphosphate | 0.30 |
| Sodium Erythorbate | 0.05 |
| Prague Powder | 0.32 |
| Spice Mix | 0.26 |
| Dextrose | 0.25 |
| Ice/water | 26.62 |
| Total | 100.00 |

Preparing the meat product includes:
(1) grinding tempered pork shoulder and backfat through a ¼″ inch plate and randomizing;
(2) tempering the mechanically deboned chicken and skim emulsion (if necessary, the meat can be stored at 4° C. until use);
(3) adding the lean pork, mechanically deboned chicken protein, salt, Prague powder, phosphate, and spice, followed by a 50/50 ice/water mixture to the cutter bowl of a Hobart Food Cutter, Model No. 84142 with 1725 rpm shaft speed and chopping the ingredients for 4 minutes at a high speed (40 adding the fat and skin emulsion, followed by the erythorbate, and chopping the ingredients for an additional 3 minutes at a high speed;
(4) adding starch to the cutter bowl and chopping the ingredients until a temperature of 12° C. is reached;
(5) scraping the hood of the cutter bowl and chopping the ingredients until a temperature of 14° C. is reached;
(6) removing the mixture and filling cellulose casings;

(7) cooking the sausages according to the schedule in Table 5; and

TABLE 5

| Wet Bulb | Dry Bulb | Smoke | Time |
|---|---|---|---|
| 0 | 96 | Off | 10 minutes |
| 110 | 150 | On | 15 minutes |
| 140 | 172 | Off | 20 minutes |
| 180 | 180 | steam cook to an | |
| | | internal temperature | |
| | | of 162□F. | |

(8) rinsing the cooked sausages and storing a 4° C.

The products hot dogs are analyzed using a TA-1-D1 texture analyzer available from Texture Technologies Corp. (Scarsdale, N.Y.) using the two cycle TPA method to determine their hardness and chewiness.

The hot dogs are analyzed without any heating (cold) (i.e., stored at room temperature before analysis) and after heating to an inside temperature of approximately 72° C. (162° F.) in a boiling water bath for from 7 to 10 minutes (hot).

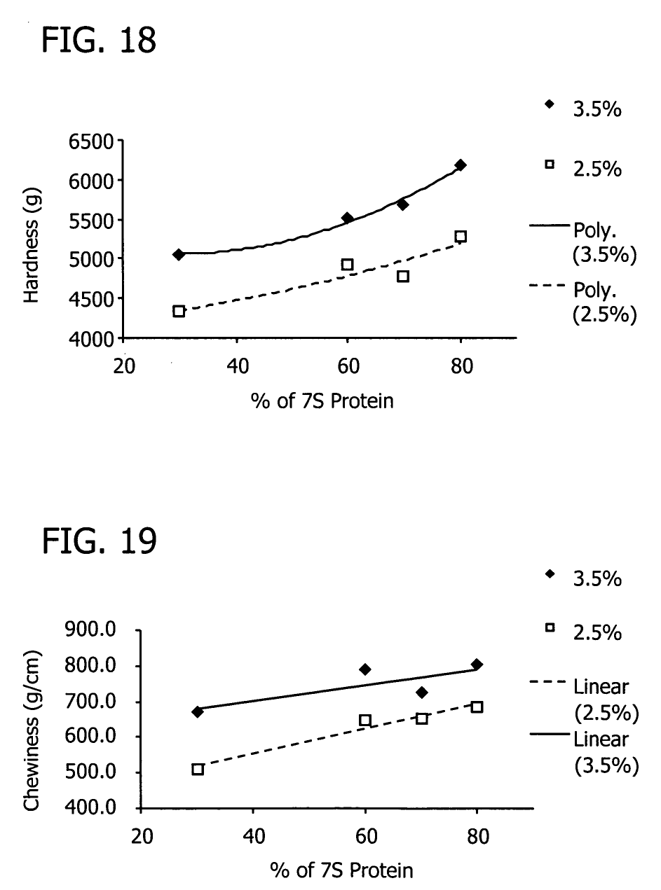

FIGS. 18 and 19 show the hardness and chewiness results for the cold and hot samples.

### EXAMPLE 7

Various meat products (e.g., hot dogs) are prepared to compare functionality of formulations containing a β-conglycinin-rich protein fraction prepared in accordance with the process of the present invention and SUPRO EX33 soy protein isolate, each available from the Solae Company (St. Louis, Mo.). The formulations are shown in Table 6. The β-conglycinin-rich fraction contain, on a protein basis, 55% β-conglycini and 33% glycinin.

TABLE 6

| Ingredient | Trial 1 | Trial 2 | Trial 2 | Trial 4 |
|---|---|---|---|---|
| Pork Shoulder 80/2 | 16.8 | 16.8 | 16.8 | 16.8 |
| Pork Back Fat 10/9 | 15.66 | 15.66 | 15.66 | 15.66 |
| Skin Emulsion | 10 | 10 | 10 | 10 |
| Chicken MDM | 20 | 20 | 20 | 20 |
| Ice/water | 28.66 | 28.66 | 28.66 | 28.66 |
| Potato Starch | 2 | 2 | 2 | 2 |
| Salt | 1.7 | 1.7 | 1.7 | 1.7 |
| Prague Powder | 0.32 | 0.32 | 0.32 | 0.32 |
| Sodium Tripoly-phosphate | 0.3 | 0.3 | 0.3 | 0.3 |
| Sodium Erythorbate | 0.05 | 0.05 | 0.05 | 0.05 |
| Dextrose | 0.25 | 0.25 | 0.25 | 0.25 |
| White Pepper | 0.15 | 0.15 | 0.15 | 0.15 |
| Nutmeg | 0.05 | 0.05 | 0.05 | 0.05 |
| Garlic Powder | 0.01 | 0.01 | 0.01 | 0.01 |
| Ginger | 0.05 | 0.05 | 0.05 | 0.05 |
| Powder | | | | |
| β-conglycinin | | 4 | 4 | |
| SUPRO EX33, Pilot | 4 | | | 4 |

The products are tested to determine hardness (i.e., gel strength) and chewiness prior to any heating (i.e., after being stored at room temperature) (cold) and after being placed in a boiling water bath (typically from 1 to 10 minutes) until the internal temperature of the sample is approximately 72° C. (162° F.) (hot). The results are shown below in Tables 7 (cold samples) and 8 (hot samples), respectively. Hardness and chewiness measurements are performed using the Instron texture analyzer described above in Example 5.

TABLE 7

| | | Hardness | Chewiness |
|---|---|---|---|
| Protein | Test # | TA | TA |
| SUPRO EX33 | 1 | 4285 | 665 |
| β-conglycinin-rich | 2 | 4771 | 809 |
| β-conglycinin-rich | 3 | 4798 | 910 |
| SUPRO EX33 | 4 | 4012 | 619 |

TABLE 8

| | | Hardness | Chewiness |
|---|---|---|---|
| Protein | Test # | TA | TA |
| SUPRO EX33 | 1 | 2187 | 407 |
| β-conglycinin-rich | 2 | 2226 | 366 |
| β-conglycinin-rich | 3 | 2244 | 440 |
| SUPRO EX33 | 4 | 1942 | 307 |

The cook yields of the products are determined by comparing the weight of the product before cooking and after cooking. The results are shown in Table 9.

TABLE 9

| Protein | Cook Yield % |
|---|---|
| SUPRO EX33 | 93.22 |
| β-conglycinin-rich | 92.66 |
| β-conglycinin-rich | 92.20 |
| SUPRO EX33 | 92.34 |

### EXAMPLE 8

Various meat-free sausage products (i.e., vegetable dogs) are prepared to determine suitability of a β-conglycinin-rich protein fraction prepared in accordance with the present process as a substitute for egg albumin in the formulation. As shown in Table 10, 5 trials are performed with the content of all but three ingredients remaining constant. Trials containing egg albumin and Supro EX33, no egg albumin and Supro EX33, and no egg albumin and a β-conglycinin-rich protein fraction are carried out. The β-conglycinin-rich fraction contain, on a protein basis, 55% β-conglycinin and 33% glycinin.

TABLE 10

| Ingredients | TRIAL | | | TRIAL | TRIAL |
|---|---|---|---|---|---|
| (% by weight) | 1 | TRIAL 2 | TRIAL 3 | 4 | 5 |
| Water/ice (30% ice) | 60.8 | 60.8 | 60.8 | 60.8 | 60.8 |
| Blue/Red solution | 0.06 | 0.06 | 0.06 | 0.06 | 0.06 |
| Caramel | 0.04 | 0.04 | 0.04 | 0.04 | 0.04 |
| Flavor | 0.4 | 0.4 | 0.4 | 0.4 | 0.4 |
| Vital Wheat gluten | 3 | 3 | 3 | 3 | 3 |
| Egg albumin (dry) | 3.2 | | | | |
| Dextrose | 0.9 | 0.9 | 0.9 | 0.9 | 0.9 |
| Sunflower oil | 18 | 18 | 18 | 18 | 18 |
| Indasia spice | 0.4 | 0.4 | 0.4 | 0.4 | 0.4 |
| L. Smoke | 0.2 | 0.2 | 0.2 | 0.2 | 0.2 |
| (Char. Hickory) | | | | | |
| β-conglycinin-rich | | 14.7 | | | 14.7 |
| SUPRO EX33 | 11.5 | | 14.7 | 14.7 | |
| Salt | 1.5 | 1.5 | 1.5 | 1.5 | 1.5 |

The products of the trials are evaluated to determine hardness (i.e., gel strength) and chewiness.

The gel strength and chewiness are determined using the Instron texture analyzer described above in Example 5.

The samples are analyzed to determine hardness (i.e., gel strength) and chewiness after being placed in a boiling water bath (typically from 1 to 10 minutes) until the internal temperature of the sample is approximately 92° C. (198° F.). The results are shown in Table 11.

TABLE 11

| | | | |
|---|---|---|---|
| | | | Chewiness |
| Protein | Test # | Hardness | (g/cm) |

| | | | |
|---|---|---|---|
| Egg White + SUPRO | 1 | 4262 | 1138 |
| EX33 | | | |
| β-conglycinin-rich | 2 | 9217 | 3727 |
| SUPRO EX33 | 3 | 3606 | 1112 |
| SUPRO EX33 | 4 | 5189 | 1790 |
| β-conglycinin-rich | 5 | 7147 | 2837 |

The samples are also analyzed for hardness and chewiness with no heating of the sample (i.e., the sample is stored at room temperature and then analyzed). The results are shown in Table 12.

TABLE 12

| | | | Chewiness | |
|---|---|---|---|---|
| Protein | Test # | Hardness | (g/cm) | Cook Yield % |
| Egg White + SUPRO | 1 | 5462 | 1056 | 89.80 |
| EX33 | | | | |
| β-conglycinin-rich | 2 | 8187 | 2205 | 89.78 |
| SUPRO EX33 | 3 | 3584 | 794 | 90.91 |
| SUPRO EX33 | 4 | 5268 | 1178 | 91.27 |
| β-conglycinin-rich | 5 | 5664 | 1390 | 90.92 |

Hardness and chewiness for retorted gels containing the samples are reported below in Table 13. For retorted gels, cans containing the sample are placed into a retort chamber where the gels are processed at 110° C. (230° F.) for approximately 68 minutes using a 3 minute vent timer. The hardness and chewiness of the gels are determined as described above.

TABLE 13

| | | | Chewiness |
|---|---|---|---|
| Protein | Test # | Hardness | (g/cm) |
| Egg White + SUPRO | 1 | 6017 | 949 |
| EX33 | | | |
| β-conglycinin-rich | 2 | 4536 | 1020 |
| SUPRO EX33 | 3 | 3911 | 769 |
| SUPRO EX33 | 4 | 4112 | 797 |
| β-conglycinin-rich | 5 | 4662 | 1219 |

### EXAMPLE 9

Various meat-free sausage products (i.e., vegetable dogs) are prepared as described above in Example 8 to determine suitability of a β-conglycinin-rich protein fraction as a substitute for egg albumin in the formulation. Various formulations containing either: egg albumin, a -conglycinin-rich fraction prepared in accordance with the present process, and SUPRO EX33 soy protein isolate available from the Solae Company (St. Louis, Mo.). The β-conglycinin-rich fraction contains 96.6% protein, on a moisture-free basis, and 73.8% β-conglycinin and 16.7% glycinin, on a protein basis. The formulations are shown below in Table 14.

TABLE 14

| | Control, | | |
|---|---|---|---|
| Ingredients | including egg | | SUPRO |
| (% by weight) | albumin | β-conglycinin-rich | EX33 |
| Water/ice (30% ice) | 60.8 | 60.8 | 60.8 |
| Blue/Red solution | 0.06 | 0.06 | 0.006 |
| Caramel | 0.04 | 0.04 | 0.04 |
| Flavor | 0.4 | 0.4 | 0.4 |
| Vital Wheat gluten | 3 | 3 | 3 |
| Dextrose | 0.9 | 0.9 | 0.9 |
| Sunflower oil | 18 | 18 | 18 |
| Indasia spice | 0.4 | 0.4 | 0.4 |
| L. Smoke | 0.2 | 0.2 | 0.2 |
| (Char. Hickory) | | | |
| Salt | 1.5 | 1.5 | 1.5 |
| Egg albumin (dry) | 3.2 | | |
| β-conglycinin-rich | | 14.7 | |
| SUPRO EX33 | | | 14.7 |

The sample containing egg albumin is analyzed to determine its hardness and chewiness using the Instron texture analyzer described above in Example 5. Three samples of the above formulation containing the β-conglycinin-rich fraction described above in the present example are analyzed to determine their hardness and chewiness. Four samples of the above formulation containing SUPRO EX33 are analyzed to determine their hardness and chewiness. The results are shown below in Table 15, including the average of the results for the formulations containing a β-conglycinin-rich fraction and SUPRO EX33. Each of the measurements are performed for cold samples (i.e., samples stored at room temperature) and hot samples (i.e., after being placed in a boiling water bath (typically from 1 to 10 minutes) until the internal temperature of the sample is approximately 72° C. (162° F.)).

TABLE 15

| | Hardness | | Chewiness | |
|---|---|---|---|---|
| | (grams) | | (grams/cm) | |
| Ingredient | Cold | Hot | Cold | Hot |
| Egg albumin | 7736 | 4114 | 1532 | 1152 |
| β-conglycinin-rich fraction | 10291 | 8287 | 3498 | 3716 |
| SUPRO EX33 | 4566 | 3722 | 957 | 1302 |

### EXAMPLE 10

Yogurt is prepared using various sources of protein: a β-conglycinin-rich fraction, a soy protein isolate containing 95% by weight protein, and XT12 soy protein isolate manufactured by the Solae Company (St. Louis, Mo.).

The yogurts are analyzed to compare their viscosities, color, and sensory characteristics.

Preparation of the yogurts includes:
(1) Dispersing protein ingredient in 38° C. (100° F.) water and heat to 74-77° C. (165-170° F.), and mixing slowly for 6 min.
(2) Dry-blending other ingredients (except oil), and adding to slurry and continue mixing 5 min.
(3) Adding vegetable oil to slurry, continue mixing 3 min.
(4) Homogenizing slurry at 500 psi in 2nd stage and 2500 psi in 1st stage.
(5) Heat mixing to 88° C. (190° F.) for 3-4 min.
(6) Cooling to 43° C. (110° F.) and incubating with Ch. Hansen YC-085 culture as follows:
   Diluting YC-085 (11.0 g) 1:10 with Butterfield sterile phosphate buffer (110 g) and adding this dilution to slurry at 2.5% (wt) of slurry.
(7) Incubating at 43° C. (110° F.) until pH <4.6 (4-5 hr).
(8) Stirring with a propeller type mixer to achieve a smooth appearance and package approximately 475 ml (16 oz.) and refrigerate.

The formulations for the yogurts containing XT12 soy protein isolate are shown in Table 16.

TABLE 16

| | |
|---|---|
| Water | 68.22 |
| Sucrose | 6.4 |
| Corn Syrup | 5.8 |
| Protein | 4.38 |
| Sunflower Oil | 0.5 |
| Maltodextrin 4DE | 3.5 |
| Maltodextrin 10DE | 10 |
| Na Citric | 0.2 |
| Food Starch | 1 |

The formulation for yogurt containing a β-conglycinin-rich fraction or the soy protein isolate described above in the present example are given in Table 17.

TABLE 17

| | |
|---|---|
| Water | 69.6 |
| Sucrose | 6.4 |
| Corn Syrup | 5.8 |
| Protein | 4.0 |
| Sunflower Oil | 0.5 |
| Maltodextrin 4DE | 3.5 |
| Maltodextrin 10DE | 10 |
| Na Citric | 0.2 |
| Food Starch | — |

The viscosity and whiteness index (WI) results for yogurt samples of the different formulations are given in Table 18. As shown, the yogurt containing a conglycinin-rich fraction exhibits the highest whiteness index.

TABLE

| | Viscosity | Whiteness Index | | | |
|---|---|---|---|---|---|
| Protein source | (centipoise) | L | a | b | WI |
| XT 12 | 3059 | 78.5 | 0.17 | 11.85 | 43.0 |
| Commercial | | | | | |
| Conglycinin- | 2280 | 77.14 | −0.1 | 8.08 | 52.9 |
| Rich | | | | | |
| Soy protein | 2579 | 77.38 | −0.07 | 10.36 | 46.3 |
| isolate | | | | | |

Sensory tastes using twelve trained descriptive panelists are performed. Yogurt samples are evaluated for nineteen flavor and eight texture attributes. Yogurt containers are combined and approximately 60 ml (2 ounces) of product is scooped into two ounce Solo cups and lidded. Each panelist independently rates the intensity of each sample's flavor attributes on a 15-point intensity scale, with 0=none and 15=very strong. Samples are randomized and presented monadically in duplicate. Analysis of Variance (ANOVA) is performed to test product and replication effects. When the ANOVA result is significant, multiple comparisons of means are performed using the Tukey's t-test. All differences are significant at an a <0.05 level unless otherwise noted.

The yogurt containing a β-conglycinin-rich fraction is significantly higher than the yogurt containing XT12 soy protein isolate in Overall Flavor Impact, Dairy and Sweetness flavors, and significantly lower in Soy/Legume Aromatics.

The results of the sensory tests are summarized in Tables 19-20. (Means in the same row followed by the same letter are not significantly different at an a=0.05 level.)

TABLE 19

| | | | Soy protein |
|---|---|---|---|
| AROMATICS | XT12 | β-conglycinin-Rich | isolate |
| Overall Flavor Impact | 6.8 b | 7.1 a | 7.0 a |
| Dairy | 0.0 b | 0.4 a | 0.2 ab |
| Cultured | 3.3 b | 3.5 a | 3.4 ab |
| Soy/Legume | 3.13 a | 2.99 b | 3.07 ab |
| Grain | 0.0 | 0.1 a | 0.1 a |
| Vegetative | 0.3 b | 0.3 b | 1.2 a |
| Sweet Aromatics | 0.0 a | 0.1 a | 0.1 a |
| Yeasty/Fermented | 0.0 a | 0.0 a | 0.0 a |
| Mineral | 0.0 a | 0.0 a | 0.0 a |
| Oxidized | 0.0 b | 0.4 a | 0.0 b |
| Fruity | 1.8 a | 1.7 a | 1.5 a |
| Cardboard | 0.0 a | 0.0 a | 0.0 a |
| Degraded Protein | 0.0 a | 0.0 a | 0.0 a |
| Other: Chemical | 0.0 b | 0.4 ab | 0.6 a |
| Other: Sour Aromatic | 0.2 a | 0.2 a | 0.2 a |

TABLE 20

| | XT12 | β-conglycinin-Rich | Soy protein isolate |
|---|---|---|---|
| BASIC TASTES | | | |
| Sweet | 3.4 b | 3.7 a | 3.8 a |
| Sour | 3.1 a | 3.2 a | 3.1 a |
| Salt | 0.9 a | 0.9 a | 0.9 a |
| Bitter | 2.7 a | 2.7 a | 2.7 a |
| CHEMICAL | | | |
| FEELING | | | |
| FACTORS | | | |
| Astringent | 3.0 a | 3.1 a | 3.2 a |
| Burn | 0.4 a | 0.6 a | 0.6 a |

### EXAMPLE 11

This example demonstrates particle size of glycinin-rich fractions in precipitations performed with and without addition of CaCl₂.

For each precipitation, the soy protein extract solution is prepared by contacting a mixture of defatted commodity white soybean flakes produced by Cargill, Inc. (Minneapolis, Minn.) and water (10:1 weight ratio of water to flakes) with sodium hydroxide at a pH of 8.5 and a temperature of 32° C. (90° F.) for 15 minutes. The soybean flakes contain 50% by weight protein. The flakes contain from 10-15%% β-conglycinin and from 40-55% glycinin, on a total protein basis.

After removal of the spent flakes by centrifuging at 3660 rpm in a Sharples 3400 decanting centrifuge available from Alfa Laval Separation Inc. (Warminster, Pa.) sodium bisulfite (0.2 g/l) is added to the resulting extract.

The extract is divided into two equal portions. The pH of the first portion is adjusted to 6.2 by addition of hydrochloric acid (1.0 M) for precipitation of a first glycinin-rich fraction. Calcium chloride (0.12 g/l solids) is added to the second portion and the mixture is stirred for 10 minutes until the calcium chloride is dissolved. The pH of the second extract portion is adjusted to pH 6.2 by addition of hydrochloric acid (1.0 M) to precipitate a second glycinin-rich fraction.

The particle size distribution of the precipitated proteins for the first and second fractions are analyzed using a Masterizer 2000 Malvern Particle Size Analyzer available from Malvern Instruments (United Kingdom). The results are shown below in Table 21.

TABLE 21

| Proportion | Particle Size (μm) | |
|---|---|---|
| of Particles | First fraction particle size | Second fraction particle |
| (% by weight) | (μm) (without CaCl₂) | size (μm) (CaCl₂) |
| 10% | 1.5 | 2.4 |
| 50% | 4.4 | 6.0 |
| 90% | 16.8 | 15.6 |

As shown in Table 21, use of CaCl₂ provide a larger average particle size and more uniform particle size.

### EXAMPLE 12

The following example details pilot plant operations for preparing β-conglycinin-rich and glycinin-rich protein fractions in accordance with the process of the present invention.

An aqueous mixture of defatted commodity white soybean flakes produced by Cargill, Inc. (Minneapolis, Minn.), 80% by weight of which can pass through a 200 mesh screen, is prepared. The soybean flakes contain 50% by weight protein. The flakes contain from 10-15% β-conglycinin and from 40-55% glycinin, on a total protein basis (i.e., from 5-7.5 β-conglycinin and from 20-27.5 glycinin, on a total weight basis).

Proteins are extracted from the filtered, collected flakes by counter-current extraction using calcium hydroxide (i.e., lime) at 10:1 total water:calcium hydroxide ratio. Approximately 3.5 kg flakes/min (8 lb flakes/min) pass through the extractor which is maintained at pH 8.5 and 32° C. (90° F.). Sodium bisulfite (0.2 g/l) is added to the extract which is contained in a 378 liter (100 gallon) tank. CaCl₂ is added to the tank to achieve a total extract calcium concentration of 0.012 g Ca⁺²/g extract solids.

Proteins are precipitated from the CaCl₂ treated extract at a pH of 6.0 by addition of hydrochloric acid (1.0 M) to the precipitation tank to produce a glycinin-rich precipitate and supernatant within the tank.

The resulting mixture is heated to a temperature of approximately 46° C. (115° F.) and clarified by centrifuging at 3660 rpm in a Sharples 3400 decanting centrifuge manufactured by Alfa Laval Separation Inc. (Warminster, Pa.) to separate the glycinin-rich fraction. The supernatant remaining after separation of the glycinin-rich fraction is cooled to approximately 20° C. (68° F.) using a plate and frame heat exchanger and then introduced to a SAMR bowl-type centrifuge manufactured by Alfa Laval Separation Inc. (Warminster, Pa.). Any overflow from the Sharples centrifuge during separation of the glycinin-rich fraction is introduced to the SAMR centrifuge.

The supernatant from the SAMR is collected in a 1900 liter (500 gallon) tank. Once approximately 1800 kg (4000 lb) of supernatant are collected in the tank, a β-conglycinin-rich fraction is precipitated at pH 4.7 by addition of hydrochloric acid (1.0 M). If necessary, the supernatant from the SAMR is cooled to 32° C. (90° F.) using a plate and frame heat exchanger.

The solids fraction obtained in the SAMR is combined with the glycinin-rich fraction obtained above and this mixture is washed, neutralized by addition of NaOH, and heated to a temperature of 150° C. (300 to 305° F.) for 9 to 15, and spray dried.

A β-conglycinin-rich fraction is recovered from the SAMR, fed to the SAMR at a rate of 34 kg/min (75 lbs/min) for further treatment, and the resulting cake is neutralized, heated, and spray dried as above.

Additional pilot plant operations are carried out as described above, except the mixture resulting from precipitation at pH 6.0 is heated to a temperature of approximately 57° C. (135° F.), clarified by centrifuging at 3660 rpm in a Sharples 3400 decanting centrifuge manufactured by Alfa Laval Separation Inc. (Warminster, Pa.) to separate the glycinin-rich fraction, and the supernatant remaining after separation of the glycinin-rich fraction is introduced to a SAMR bowl-type centrifuge manufactured by Alfa Laval Separation Inc. (Warminster, Pa.) without cooling.

The protein content of the β-conglycinin-rich and glycinin-rich fractions obtained in the first pilot plant operation (46° C. (115° F.) heat treatment before, and cooling of the supernatant after, centrifuging) and additional pilot plant operations (57° C. (135° F.) heating of glycinin-rich precipitate and supernatant mixture without cooling of supernatant after centrifuging) are given below in Table 22.

TABLE 22

| Operation | β-conglycinin-rich | Glycinin-rich | Total |
|---|---|---|---|
| First | 2.58 | 36.45 | 39.03 |
| Additional | 4.04 | 33.43 | 37.47 |

As shown in Table 22, for the first operation, an overall protein yield of from approximately 55-80% is achieved. Similarly, for the additional operation, an overall protein yield of from approximately 54-75% is achieved.

The protein content of the fractions, based on their total protein content, obtained in the additional operations are described below in Table 23.

TABLE 23

| Fraction | β-conglycinin | Glycinin | Others |
|---|---|---|---|
| β-conglycinin-rich | 55.0 | 34.1 | 10.9 |
| Glycinin-rich | 8.76 | 75.9 | 15.3 |

### EXAMPLE 13

The following example details pilot plant operations for preparing β-conglycinin-rich and glycinin-rich protein fractions in accordance with the process of the present invention.

An aqueous mixture of defatted commodity white soybean flakes produced by Cargill, Inc. (Minneapolis, Minn.), 80% by weight of which can pass through a 200 mesh screen, is prepared. The soybean flakes contain 50% by weight protein. The flakes contain from 10-15% -conglycinin and from 40-55% glycinin, on a total protein basis (i.e., from 5-7.5 β-conglycinin and from 20-27.5 glycinin, on a total weight basis).

Proteins are extracted from the filtered, collected flakes by counter-current extraction using calcium hydroxide (i.e., lime) at 10:1 total water: calcium hydroxide ratio. Approximately 3.5 kg flakes/min (8 lb flakes/min) passed through the extractor which is maintained at pH 8.5 and 32° C. (90° F.). Sodium bisulfite (0.2 g/l) is added to the extract which is contained in a 378 liter (100 gallon) tank. CaCl₂ is added to the tank to achieve a total extract calcium concentration of 0.012 g Ca⁺²/g extract solids.

Proteins are precipitated from the CaCl₂ treated extract at a pH of 6.0 by addition of hydrochloric acid (1.0 M) to the precipitation tank to produce a glycinin-rich precipitate and supernatant within the tank.

The resulting mixture is heated to a temperature of approximately 63° C. (145° F.) and clarified by centrifuging at 3660 rpm in a Sharples 3400 decanting centrifuge manufactured by Alfa Laval Separation Inc. (Warminster, Pa.) to separate the glycinin-rich fraction. The supernatant remaining after separation of the glycinin-rich fraction is cooled to approximately 32° C. (90° F.) using a plate and frame heat exchanger and then introduced to a SAMR bowl-type centrifuge manufactured by Alfa Laval Separation Inc. (Warminster, Pa.).

The supernatant from the SAMR is collected in a 1900 liter (500 gallon) tank. Once approximately 1800 kg (4000 lb) of supernatant are collected in the tank, a β-conglycinin-rich fraction is precipitated at pH 4.7 by addition of hydrochloric acid (1.0 M).

The solids fraction obtained in the SAMR is combined with the glycinin-rich fraction obtained above and this mixture is washed, neutralized by addition of NaOH, and heated to a temperature of 150° C. (300 to 305° F.) for 9 to 15 seconds, and spray dried.

A -conglycinin-rich fraction is recovered from the SAMR, fed to the SAMR at a rate of 34 kg/min (75 lbs/min) for further treatment, and the resulting cake is neutralized, heated, and spray dried as above.

The total protein content of the β-conglycinin-rich and glycinin-rich fractions are summarized below in Table 24.

TABLE 24

| | β-conglycinin-rich | Glycinin-rich | |
|---|---|---|---|
| | fraction | fraction | Total |
| Total protein | 8.56 | 42.61 | 51.17 |

As shown in Table 24, an overall protein yield of approximately 50% is achieved.

The protein contents of the β-conglycinin-rich and glycinin-rich fractions are summarized below in Table 25.

TABLE 25

| | | | Other |
|---|---|---|---|
| Fraction | β-conglycinin (%) | Glycinin (%) | Proteins (%) |
| β-conglycinin-rich | 54.0 | 33.0 | 13.0 |
| fraction | | | |
| Glycinin-rich | 20.2 | 69.3 | 10.5 |
| fraction | | | |

What is claimed is:

1-152. (canceled)

153. A process for preparing a glycinin-rich protein fraction and a β-conglycinin-rich protein fraction, the process comprising:
in a first precipitation, adjusting the pH of a dispersion of soy protein in a liquid medium to less than 5.3 thereby precipitating a glycinin-rich fraction from said dispersion and forming a supernatant liquid medium comprising β-conglycinin, said dispersion having an ionic strength of from 0.04 to 0.07 and said glycinin-rich fraction having a protein content of at least 50% by weight glycinin based on the total protein content of said glycinin-rich fraction,
separating said glycinin-rich fraction from said supernatant liquid medium, and
in a second precipitation, precipitating a β-conglycinin-rich fraction from said supernatant liquid medium, said β-conglycinin-rich fraction comprising at least 40% by weight β-conglycinin and from 10% to 25% by weight glycinin based on the total protein content of said β-conglycinin-rich fraction.

154. A process as set forth in claim 153 wherein the pH of said supernatant liquid medium is adjusted to a pH of from 4.5 to 5.3 for precipitating said β-conglycinin rich fraction.

155. A process as set forth in claim 153 wherein said glycinin-rich fraction comprises at least 10% by weight of said glycinin present in said dispersion of soy protein in a liquid medium.

156. A process as set forth in claim 153 wherein said glycinin-rich fraction comprises at least 60% by weight glycinin based on the total protein content of said glycinin-rich fraction.

157. A process as set forth in claim 153 wherein said glycinin-rich fraction comprises at least 50% by weight soy protein.

158. A process as set forth in claim 153 wherein said glycinin-rich fraction comprises less than 20 ppm bisulfite.

159. A process as set forth in claim 153 wherein said β-conglycinin-rich fraction contains at least 10% by weight of said β-conglycinin present in said dispersion of soy protein in a liquid medium.

160. A process as set forth in claim 153 wherein said β-conglycinin-rich fraction comprises from 40% to 80% by weight β-conglycinin based on the total protein content of said β-conglycinin-rich fraction.

161. A process as set forth in claim 153 wherein said β-conglycinin-rich fraction comprises at least 80% by weight soy protein.

162. A process as set forth in claim 153 wherein said β-conglycinin-rich fraction comprises less than 20 ppm bisulfite.

163. A process as set forth in claim 153 wherein at least 80% by weight of said soy protein in said β-conglycinin-rich fraction has a molecular weight of less than 800,000 daltons.

164. A process as set forth in claim 153 wherein at least 60% by weight of said soy protein in said β-conglycinin-rich fraction has a molecular weight of from 1350 to 380,000 daltons.

165. A process as set forth in claim 153 wherein said dispersion of soy protein in a liquid medium comprises soy flakes, soy flour, soy grits, soy meal, a soy protein concentrate, a soy protein isolate, or combinations thereof.

166. A process as set forth in claim 153 further comprising introducing an alkali metal hydroxide selected from the group consisting of sodium hydroxide, calcium hydroxide, and potassium hydroxide to said supernatant liquid medium.

167. A process for preparing a glycinin-rich protein fraction and a β-conglycinin-rich protein fraction, the process comprising:
introducing a source of a divalent metal ion to a dispersion comprising soy protein in a liquid medium,
precipitating a glycinin-rich fraction from said dispersion, thereby forming a supernatant liquid medium comprising β-conglycinin,
separating said glycinin-rich fraction from said supernatant liquid medium, and precipitating a β-conglycinin-rich fraction from said supernatant liquid medium.

168. A process as set forth in claim 167 wherein said β-conglycinin-rich fraction comprises a divalent metal cross-linked precipitate.

169. A process as set forth in claim 167 wherein said source of a divalent metal ion comprises a salt of Ca⁺² or Mg⁺².

170. A process as set forth in claim 167 wherein the ionic strength of said dispersion is from 0.02 to 0.1.

171. A process as set forth in claim 167 wherein said glycinin-rich fraction comprises at least 10% by weight of said glycinin present in said dispersion of soy protein in a liquid medium.

172. A process as set forth in claim 167 wherein said glycinin-rich fraction comprises at least 50% by weight glycinin based on the total protein content of said glycinin-rich fraction.

173. A process as set forth in claim 167 wherein said glycinin-rich fraction comprises at least 50% by weight soy protein.

174. A process as set forth in claim 167 wherein said glycinin-rich fraction comprises less than 20 ppm bisulfite.

175. A process as set forth in claim 167 wherein said β-conglycinin-rich fraction contains at least 10% by weight of said β-conglycinin present in said dispersion of soy protein in a liquid medium.

176. A process as set forth in claim 167 wherein said β-conglycinin-rich fraction comprises from 40% to 80% by weight β-conglycinin based on the total protein content of said β-conglycinin-rich fraction.

177. A process as set forth in claim 167 wherein said β-conglycinin-rich fraction comprises at least 80% by weight soy protein.

178. A process as set forth in claim 167 wherein said β-conglycinin-rich fraction comprises less than 20 ppm bisulfite.

179. A process as set forth in claim 167 wherein at least 60% by weight of said soy protein in said β-conglycinin-rich fraction has a molecular weight of from 1350 to 380,000 daltons.

180. A process as set forth in claim 167 wherein said dispersion of soy protein in a liquid medium comprises soy flakes, soy flour, soy grits, soy meal, a soy protein concentrate, a soy protein isolate, or combinations thereof.

181. A process as set forth in claim 167 further comprising introducing an alkali metal hydroxide selected from the group consisting of sodium hydroxide, calcium hydroxide, and potassium hydroxide to said supernatant liquid medium.

182. A process as set forth in claim 167 wherein said glycinin-rich fraction comprises discrete particles having a particle size distribution, on a particle diameter basis, of from 2 μm to 16 μm.

183. A vegetable protein fraction comprising from 40% to 80% by weight β-conglycinin and at least 10% by weight glycinin, based on the total protein content of said fraction, said protein fraction being further characterized by a nitrogen solubility index of at least 80%.

184. A vegetable protein fraction as set forth in claim 183 having a salt tolerance index of from 75% to 85%.

185. A vegetable protein fraction as set forth in claim 183 wherein said fraction comprises greater than 12% by weight glycinin, based on the total protein content of said protein fraction.

186. A vegetable protein fraction as set forth in claim 183 comprising from 40% to 75% by weight β-conglycinin and between 10% and 15% by weight glycinin, based on the total protein content of said fraction.

187. A vegetable protein fraction as set forth in claim 183 wherein said vegetable protein fraction comprises at least 80% by weight soy protein.

188. A vegetable protein fraction as set forth in claim 183 wherein an aqueous dispersion consisting of 7% by weight of said protein fraction has a viscosity of from 20 to 225 centipoise at pH of 5.6 and 20° C.

189. A vegetable protein fraction as set forth in claim 183 wherein an aqueous dispersion consisting of 7% by weight of said protein fraction and 2% by weight NaCl exhibits a viscosity of from 20 to 200 centipoise at pH of 5.6 and 20° C.

190. A vegetable protein fraction as set forth in claim 183 wherein an aqueous dispersion of said protein fraction having a solids content of 5% has a whiteness index of from 25 to 45.

191. A vegetable protein fraction as set forth in claim 183 wherein a powder of said protein fraction having a moisture content of less than 5% has a whiteness index of from 50 to 60.

192. A vegetable protein fraction as set forth in claim 183 wherein an aqueous dispersion consisting of 10% by weight of said protein fraction exhibits a percent transmittance at 800 nm of from 70% to 95%.

193. A vegetable protein fraction as set forth in claim 183 being further characterized by a gel consisting of said protein fraction and water at a 1:5 weight ratio of protein fraction to water having a gel strength of at least 10,000 grams.

194. A vegetable protein fraction as set forth in claim 193 wherein a gel consisting of said fraction and water at a 1:5 weight ratio of protein fraction to water has a gel strength of from 12,000 grams to 16,000 grams.

195. A vegetable protein fraction as set forth in claim 183 wherein a gel consisting of water, said fraction at a 1:5 weight ratio of protein fraction to water, and 2% by weight NaCl has a gel strength of at least 8000 grams.

196. A vegetable protein fraction as set forth in claim 183 being further characterized by an oil in water emulsion consisting of said protein fraction at a weight ratio to water of from 1:4 to 1:6 and consisting of said protein fraction and oil at a weight ratio of protein fraction to oil of from 1:4 to 1:5 exhibiting an emulsion strength of from 70 to 185 grams.

197. A vegetable protein fraction as set forth in claim 183 wherein an aqueous dispersion consisting of 2% by weight of said protein fraction has an emulsion capacity of at least 500 grams oil/gram protein at a pH of 7.

198. A vegetable protein fraction as set forth in claim 197 wherein an aqueous dispersion consisting of 2% by weight of said protein fraction has an emulsion capacity of from 500 to 900 grams oil/gram protein at a pH of 7.

199. A vegetable protein fraction as set forth in claim 183 wherein the weight ratio of β-conglycinin to glycinin in said protein fraction is least 2.5:1.

200. A vegetable protein fraction as set forth in claim 183, said vegetable protein fraction having been heated to a temperature of at least 95° C. (203° F.).

201. A vegetable protein fraction comprising from 50% to 95% by weight glycinin, based on the total protein content of said fraction, said protein fraction being further characterized by a nitrogen solubility index of less than 80%.

202. A vegetable protein fraction as set forth in claim 201 having a salt tolerance index of less than 65%.

203. A vegetable protein fraction as set forth in claim 201 wherein an aqueous dispersion consisting of 7% by weight of said protein fraction and 2% by weight NaCl exhibits a viscosity of less than 50 centipoise at pH 5.6 and 20° C.

204. A vegetable protein fraction as set forth in claim 201 wherein an aqueous dispersion of said protein fraction having a solids content of 5% has a whiteness index of at least 40.

205. A vegetable protein fraction as set forth in claim 201 wherein a powder of said protein fraction having a moisture content of less than 5% has a whiteness index of from 50 to 60.

206. A vegetable protein fraction as set forth in claim 201 wherein an aqueous dispersion consisting of 10% by weight of said protein fraction exhibits a percent transmittance at 800 nm of less than 10%.

207. A vegetable protein fraction as set forth in claim 201 wherein a gel consisting of said protein fraction and water at a 1:5 weight ratio of protein fraction to water has a gel strength of less than 600 grams.

208. A vegetable protein fraction as set forth in claim 201 wherein a gel consisting of water, said fraction at a 1:5 weight ratio of protein fraction to water, and 2% by weight NaCl has a gel strength of less than 1500 grams.

209. A vegetable protein fraction as set forth in claim 201 wherein the weight ratio of glycinin to β-conglycinin in said protein fraction is at least 10:1.

210. A vegetable protein fraction as set forth in claim 201 wherein said vegetable protein fraction comprises at least 80% by weight soy protein.

211. A vegetable protein fraction as set forth in claim 201 wherein said vegetable protein fraction is heated to a temperature of at least 95° C. (203° F.).

212. A meat substitute comprising a coherent mass comprising water, an edible oil, and at least 10% by weight vegetable protein, wherein said vegetable protein comprises a vegetable protein fraction comprising at least 40% by weight β-conglycinin and at least 10% by weight glycinin, based on the total protein content of said meat substitute, said meat substitute further characterized by:
an emulsification capacity of at least 800 grams oil/gram protein.

213. A meat substitute as set forth in claim 212 wherein said vegetable protein fraction contains between 40% and 80% β-conglycinin and between 10% and 20% glycinin, based on the total protein content of said meat substitute.

214. A meat substitute as set forth in claim 212 wherein the ratio of β-conglycinin to glycinin in said vegetable protein fraction is at least 2.5.

215. A meat substitute as set forth in claim 212 wherein said vegetable protein is further characterized by the following properties:
an aqueous dispersion consisting of 10% by weight of said protein fraction exhibiting a percent transmittance at 800 nm of at least 70%;
a gel consisting of said fraction and water at a 1:5 weight ratio of protein fraction to water having a gel strength of at least 8000 grams;
an oil in water emulsion consisting of said protein fraction and water at a weight ratio of protein fraction to water of from 1:4 to 1:6 and consisting of said protein fraction and oil at a weight ratio of protein fraction to oil of from 1:4 to 1:5 exhibiting an emulsion strength of from 120 grams to 400 grams.

216. A meat substitute as set forth in claim 212 comprising between 5% and 25% by weight of said vegetable protein fraction, between 10% and 30% by weight of said edible oil, and between 40% and 75% by weight water.

217. A meat substitute as set forth in claim 216 wherein said edible oil comprises a polyunsaturated vegetable oil.

218. A meat substitute as set forth in claim 216 further comprising flavoring agents.

219. A meat substitute as set forth in claim 216 further comprising a carbohydrate.

220. A meat substitute as set forth in claim 216 further comprising between 0.2% and 2.5% by weight salt, between 10% and 30% by weight polyunsaturated vegetable oil, and liquid smoke in a proportion sufficient to impart a detectable smoky flavor.

221. A meat substitute as set forth in claim 216 wherein said coherent mass exhibits a hardness of at least 5000 grams.

222. A meat substitute as set forth in claim 216 wherein said coherent mass exhibits a chewiness of at least 2000 g/cm.

223. A meat substitute as set forth in claim 216 of elongate generally cylindrical conformation in the form of a sausage.
